(19) United States
(12) Patent Application Publication
(10) Pub. No.: US 2010/0259621 A1
(43) Pub. Date: Oct. 14, 2010

(54) Image Processing Apparatus, Image Processing Method and Storage Medium

(75) Inventor: Yosuke Bando, Tokyo (JP)

Correspondence Address: SPRINKLE IP LAW GROUP, 1301 W. 25TH STREET, SUITE 408, AUSTIN, TX, 78705, US

(73) Assignee: Kabushiki Kaisha Toshiba, Tokyo (JP)

(21) Appl. No.: 12/726,227

(22) Filed: Mar. 17, 2010

(30) Foreign Application Priority Data
Apr. 9, 2009 (JP) 2009-095194

(51) Int. Cl. H04N 17/00

(52) U.S. Cl. 348/180; 348/E17.001

(57) ABSTRACT

An image processing apparatus includes a discontinuity detecting unit configured to detect a discontinuity between frames in stream data and, when detecting a discontinuity, add predetermined discontinuity information and output the image data and header information, a FIFO configured to store the image data and the header information in association with each frame, and a frame-to-be-processed determining unit configured to determine, for continuous frames, elapsed time from the start of the stream on the basis of the PTSs of two continuous frames, determine, for a discontinuous frame, elapsed time based on the PTS and frame rate of a frame preceding or succeeding the point at which a discontinuity exists, and determine a frame to which image processing is to be applied based on the determined elapsed time and time intervals f set for specifying a frame to which the image processing is to be applied.

### CROSS-REFERENCE TO RELATED APPLICATIONS

This application is based upon and claims the benefit of priority from the prior Japanese Patent Application No. 2009-95194 filed in Japan on Apr. 9, 2009; the entire contents of which are incorporated herein by reference.

### BACKGROUND OF THE INVENTION

1. Field of the Invention

The present invention relates to an image processing apparatus, an image processing method and a storage medium for the image processing apparatus and the image processing method and, in particular, to an image processing apparatus and an image processing method that determines frames to be extracted to which image processing is to be applied from stream data and a storage medium for the image processing apparatus and the image processing method.

2. Description of the Related Art

Various techniques such as techniques for smoothly displaying moving images on a moving image playback apparatus during moving image playback and frame rate control techniques have been proposed such as the techniques disclosed in Japanese Patent Application Laid-Open Publication No. 2005-311424 and No. 2002-125226.

Today's digital cameras include the function of detecting the face of a subject during photographing. Processing such as shutter release timing control and color adjustment in image processing based on the face detection function are performed in such digital cameras.

Such functions are not yet available for moving image stream data. However, real-time image processing of moving images is useful in moving image playback apparatuses. For example, if a moving image playback apparatus capable of recording television broadcast contents could perform real-time face detection processing while recording a broadcast content so that information concerning detected human faces becomes available upon completion of the recording, the face information can be used to search for a desired scene, for example. That is, if predetermined image processing can be performed during recording, it would be a useful aid for users in viewing a recorded program.

Since adjacent frames in moving images are often similar to each other, in general, image processing does not need to be performed on every frame. Instead, frames may be extracted at regular intervals. In other words, in many cases, several frames may be skipped at regular intervals and image processing may be performed only on the frames not skipped. The skipping can reduce the load of image processing and the amount of resulting output data.

On the other hand, if the amount of computation in image processing depends on image contents, processing time per frame varies and frame extraction at regular intervals may not catch up with real-time processing. Therefore, frames to which processing is to be applied may have to be skipped on the image processing apparatus.

In a system that performs real-time image processing of moving images, it is desirable that frames to which processing is to be applied be uniquely determined in an input moving image stream. This is because, excluding the case where frames are skipped for securing real time processing, when certain image processing is performed on the same input moving image stream more than once and if the image processing is applied on different frames at different times at which the image processing is performed, different results may be produced by the image processing. For example, when face detection image processing is applied to the same stream more than once, it is desirable that the result of the first face detection image processing and the result of the second face detection image processing be the same.

Furthermore, if the reproducibility of the result of image processing can be ensured, development and correction of defects in an image processing apparatus and an image processing program will be facilitated.

One possible method for determining frames to be extracted may be to use a timer to measure time intervals to extract frames to be processed at regular intervals. However, since the amount of computation required for image processing depends on contents of images as stated above, the extraction intervals in this method can vary depending on the timing of decoding or image processing of moving images.

Another possible method for determining frames to be extracted may be to count frames to apply processing to, for example, every third frame. In this method, however, if a data error occurs in a stream data for some reason such as some temporary problem during data transmission, it may be impossible to know how many frames have been lost due to the error. Therefore, in this method, frames are not extracted at desired intervals in playback time and frames extracted from a normal stream after a data error has been corrected can differ from frames that would be extracted from the stream if the stream were data-error free.

As can be seen from the foregoing, it has been desirable but impossible to uniquely determine frames in a moving image stream to which image processing is to be applied if there are variations in decoding time or image processing time or missing frames.

When image processing is distributed between multiple apparatuses and executed in parallel, and one of two apparatuses, for example, performs first image processing and the other performs second image processing on the same frame of a moving image stream, it is impossible to cause the apparatuses to perform processing on the same frames, unless an extra mechanism for synchronization or communication between the apparatuses is provided.

### BRIEF SUMMARY OF THE INVENTION

According to one aspect of the present invention, there is provided an image processing apparatus including: a discontinuity detecting unit configured to detect discontinuity between frames in stream data having a plurality of pieces of frame data including image data, a playback time instant, and a frame rate and, when the discontinuity is detected, add predetermined discontinuity information indicating the presence of the discontinuity and output the image data and header information of each frame; a FIFO memory configured to store the image data and the header information from the discontinuity detecting unit in association with each of the frames; and a frame-to-be-processed determining unit configured to determine, for a frame read from the FIFO memory without the discontinuity information, elapsed time from the start of the stream data on the basis of the playback time instants of two continuous frames, and determine, for a frame to which the discontinuity information is added, elapsed time from the start of the stream data on the basis of the playback time instant and the frame rate of a frame preceding or succeeding the point at which the discontinuity exists, and determine a frame to which the image processing is to be applied or a frame to which the image processing is not to be applied, on the basis of the determined elapsed time and time intervals set for specifying a frame to which the image processing is to be applied.

According to another aspect of the present invention, there is provided an image processing method including: detecting discontinuity between frames in stream data having a plurality of pieces of frame data including image data, a playback time instant, and a frame rate and, when the discontinuity is detected, adding predetermined discontinuity information indicating the presence of the discontinuity and outputting the image data and header information of each frame; and

for a frame without the discontinuity information read from the FIFO memory configured to store the output image data and the output header information in association with each of the frames, determining elapsed time from the start of stream data on the basis of the playback time instants of two continuous frames, and for a frame to which the discontinuity information is added, determining elapsed time from the start of the stream data on the basis of the playback time instant and the frame rate of a frame preceding or succeeding the point at which the discontinuity exists, and determining a frame to which the image processing is to be applied or a frame to which the image processing is not to be applied, on the basis of the determined elapsed time and time intervals set for specifying a frame to which the image processing is to be applied.

### BRIEF DESCRIPTION OF THE DRAWINGS

FIG. 1 is a block diagram illustrating a configuration of an image processing apparatus according to an embodiment of the present invention;

FIG. 2 is a diagram illustrating the configuration of the image processing apparatus and a flow of image processing by the image processing apparatus according to the embodiment of the present invention;

FIG. 3 is a diagram illustrating a configuration of data outputted from a decoder according to the embodiment of the present invention;

FIG. 4 is a diagram illustrating how discontinuity flags and dummy frames are added by a PTS discontinuity detecting unit 22 according to the embodiment of the present invention;

FIG. 5 is a flowchart illustrating an exemplary processing flow in the PTS discontinuity detecting unit 22 according to the embodiment of the present invention;

FIG. 6 is a diagram illustrating data push into a FIFO 21 when there is an available FIFO block in the FIFO 21;

FIG. 7 is a diagram illustrating data push into the FIFO 21 when there is no available FIFO block in the FIFO 21;

FIG. 8 is a diagram illustrating a structure of data stored in the FIFO 21;

FIG. 9 is a diagram illustrating a range of data read, or popped, from the FIFO 21;

FIG. 10 is a diagram illustrating a case where a portion of continuous frame data has been lost due to an overwrite when the frame data has been pushed into the FIFO 21;

FIG. 11 is a diagram illustrating a case where a portion of discontinuous frame data has been lost due to an overwrite when the frame data has been pushed into the FIFO 21;

FIG. 12 is a diagram illustrating a header section 31 and an image section 32 when a frame data sequence is pushed into the FIFO 21;

FIG. 13 is a diagram illustrating a header section 31, an image section 32, and a pre-read header section 31a that are popped when the frame data sequence illustrated in FIG. 12 is pushed into the FIFO 21 without an overwrite:

FIG. 14 is a diagram illustrating a frame data sequence that includes a discontinuous portion is pushed into the FIFO 21;

FIG. 15 is a diagram illustrating a header section 31, an image section 32 and a pre-read header section 31a that are popped from the FIFO 21 when multiple pieces of frame data in the frame data sequence illustrated in FIG. 14 have been lost due to an overwrite;

FIG. 16 is a diagram illustrating an operation for pushing data into the FIFO 21 and an operation for popping data from the FIFO 21;

FIG. 17 is a diagram illustrating an operation performed by a supplementary header adding unit 23 to generate supplementary header information Shd and write the supplementary header information into a FIFO block along with image data Im and header information Hd when there is an available FIFO block in the FIFO 21;

FIG. 18 is a diagram illustrating data write into the FIFO 21 when there is an available FIFO block in the FIFO 21;

FIG. 19 is a diagram illustrating data write into the FIFO 21 when there is an available FIFO block in the FIFO 21;

FIG. 20 is a diagram illustrating data write into the FIFO 21 when there is an available FIFO block in the FIFO 21;

FIG. 21 is a diagram illustrating data write into the FIFO 21 when there is an available FIFO block in the FIFO 21;

FIG. 22 is a diagram illustrating an operation performed by the supplementary header adding unit 23 to generate supplementary header information Shd and write the supplementary header information into the FIFO block of the FIFO 21 along with image data Im and header information Hd when there is no available FIFO block in the FIFO 21;

FIG. 23 is a diagram illustrating data write into the FIFO 21 when there is no available FIFO block in the FIFO 21;

FIG. 24 is a diagram illustrating data write into the FIFO 21 when there is no available FIFO block in the FIFO 21;

FIG. 25 is a diagram illustrating data write into the FIFO 21 when there is no available FIFO block in the FIFO 21;

FIG. 26 is a diagram illustrating data write into the FIFO 21 when there is no available FIFO block in the FIFO 21;

FIG. 27 is a diagram illustrating data write into the FIFO 21 when there is no available FIFO block in the FIFO 21;

FIG. 28 is a diagram illustrating data write into the FIFO 21 when there is no available FIFO block in the FIFO 21;

FIG. 29 is a diagram illustrating data write into the FIFO 21 when there is no available FIFO block in the FIFO 21;

FIG. 30 is a diagram illustrating data write into the FIFO 21 when there is no available FIFO block in the FIFO 21;

FIG. 31 is a diagram illustrating a structure of data generated and outputted by a pre-read header manipulating unit 24;

FIG. 32 is a diagram illustrating a configuration of output data when an overwrite does not occur;

FIG. 33 is a diagram illustrating a configuration of output data when an overwrite does not occur;

FIG. 34 is a diagram illustrating a configuration of output data when an overwrite does not occur;

FIG. 35 is a diagram illustrating a configuration of output data when a normal frame has been overwritten with a stream end frame (pattern 8) and the normal frame is outputted;

FIG. 36 is a diagram illustrating a configuration of output data when a normal frame has been overwritten with another normal frame (pattern 1) and the normal frame is outputted;

FIG. 37 is a diagram illustrating a configuration of output data when a normal frame has been overwritten with a sequence end frame (pattern 2) and the normal frame is outputted;

FIG. 38 is a diagram illustrating a configuration of output data when a stream change frame has been overwritten with a normal frame (pattern 7) and a dummy frame is outputted;

FIG. 39 is a diagram illustrating a configuration of output data when a sequence end frame has been overwritten with a stream change frame (pattern 5) and a normal frame is outputted;

FIG. 40 is a diagram illustrating a configuration of output data when the stream change frame in FIG. 39 has not been overwritten and a normal frame is outputted;

FIG. 41 is a diagram illustrating a configuration of output data when the stream change frame in FIG. 39 has been overwritten with a normal frame and a normal frame is outputted (pattern 6);

FIG. 42 is a diagram illustrating a configuration of output data when data is popped after the operation of FIG. 41;

FIG. 43 is a diagram illustrating relationship between frames presented and time intervals f for specifying frames to which image processing is to be applied;

FIG. 44 is a diagram illustrating how to obtain elapsed time from a PTS;

FIG. 45 is a diagram illustrating how to obtain elapsed time from a PTS;

FIG. 46 is a diagram illustrating how to obtain elapsed time from a PTS;

FIG. 47 is a diagram illustrating how to obtain elapsed time from a PTS;

FIG. 48 is a diagram illustrating how to obtain elapsed time from a PTS;

FIG. 49 is a diagram illustrating how to obtain elapsed time from a PTS; and

FIG. 50 is a flowchart illustrating an exemplary process flow in a frame-to-be-extracted determining unit 25.

### DETAILED DESCRIPTION OF THE INVENTION

Embodiments of the present invention will be described with reference to the accompanying drawings. The embodiments will be described with respect to moving image stream data contained in television broadcast waves by way of example. However, the moving image stream data may be moving image stream data stored on a storage medium in a video camera or digital camera, a storage medium such as a DVD, or moving image stream data distributed through a network such as the Internet.

### (General Configuration)

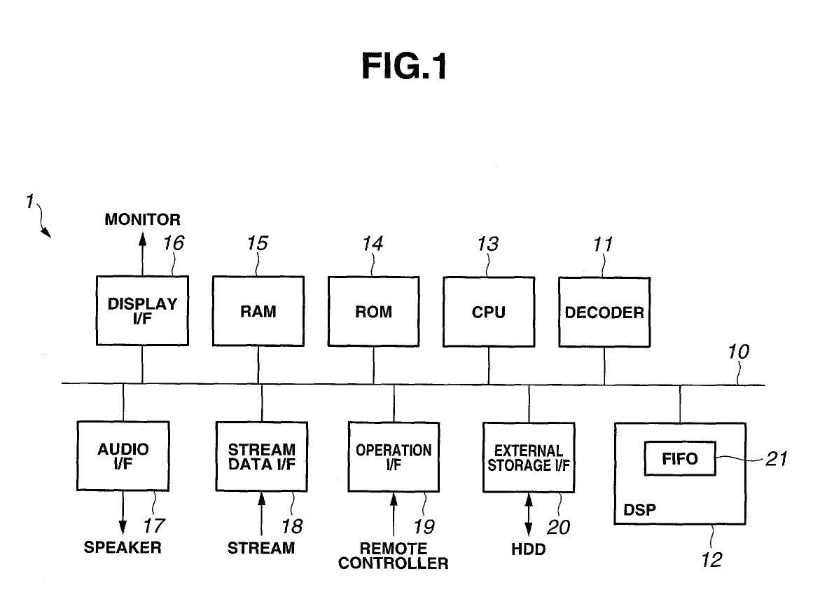

FIG. 1 is a block diagram illustrating a configuration of an image processing apparatus according to an embodiment of the present invention. As illustrated in FIG. 1, the image processing apparatus 1 includes a decoder 11, a digital signal processor (hereinafter referred to as the DSP) 12 which is a signal processor including an image processing unit, a central processing unit (CPU) 13 configured to control the entire image processing apparatus 1, a ROM 14 on which a program to be executed by the CPU 13 is stored, a RAM 15 which is a working memory area used by the CPU 13 during execution of a program, a display interface (hereinafter abbreviated as I/F) 16 for displaying an image on a monitor (not shown), an audio I/F 17 for outputting sound through a speaker (not shown), a stream data I/F 18 into which moving image stream data is inputted, an operation I/F 19 into which an operation signal is inputted from a device such as a remote controller, a keyboard, and operation buttons, and an external storage I/F 20 for inputting and outputting data to and from a hard disk drive (hereinafter abbreviated as HDD) which is a storage device. These components such as the decoder 11 in the image processing apparatus 1 are interconnected through a bus 10. The DSP 12 has a FIFO (First In First Out) memory (hereinafter referred to as the FIFO) 21. A tuner and the like that receives television broadcasts is connected to the stream data I/F 18.

A storage medium device that reads moving image stream data (hereinafter simply referred to as a stream) from a storage medium such as a DVD or HDD may be connected to the stream data I/F 18 or a network such as the Internet may be connected to the storage medium data I/F 18 and streams other than television broadcast streams may be used. A stream includes multiple pieces of frame data.

The decoder 11 decodes a stream and outputs image data and header information including time information.

The FIFO 21 stores information including image data Im and header information Hd of each frame from the decoder 11. The DSP 12 performs predetermined image processing on image data and outputs the result of the image processing.

The image processing apparatus 1 is an apparatus configured to perform an operation, for example playback or recording a stream, in response to an instruction from a user. Specifically, when a user operates a remote controller for the image processing apparatus 1, an operation signal is provided from the remote controller to the CPU 13 through the operation I/F 19. For example, when an instruction for watching a television program is issued, the CPU 13 can receive a stream contained in a received television broadcast signal through the stream data I/F 18, cause the decoder 11 to decode the stream, and eventually display images from the decoded image data on the monitor (not shown) and cause the speaker (not shown) to output sound. When an instruction for recording a television program is issued, the CPU 13 can receive the specified program, cause the decoder 11 to decode, and store the decoded image data in the HDD (not shown), for example, through the external storage I/F 20. The image processing apparatus 1 is also capable of causing the decoder 11 to decode a stream stored in the HDD or a storage medium such as a DVD, or a stream received through a network such as the Internet and playing back the stream.

The DSP 12 performs predetermined image processing such as face detection processing on frame images as will be described later. For example, when a user issues a predetermined instruction to the image processing apparatus 1, the CPU 13 can cause the DSP 12 to perform the predetermined image processing on decoded image data being received, played back, or recorded and output the result of the image processing. As will be described later, the DSP 12 extracts frames from stream data and performs the image processing only on the extracted frames, rather than performing the image processing on all of the decoded frames. Frames to be extracted from the stream are uniquely determined in the stream.

### (General Process Flow)

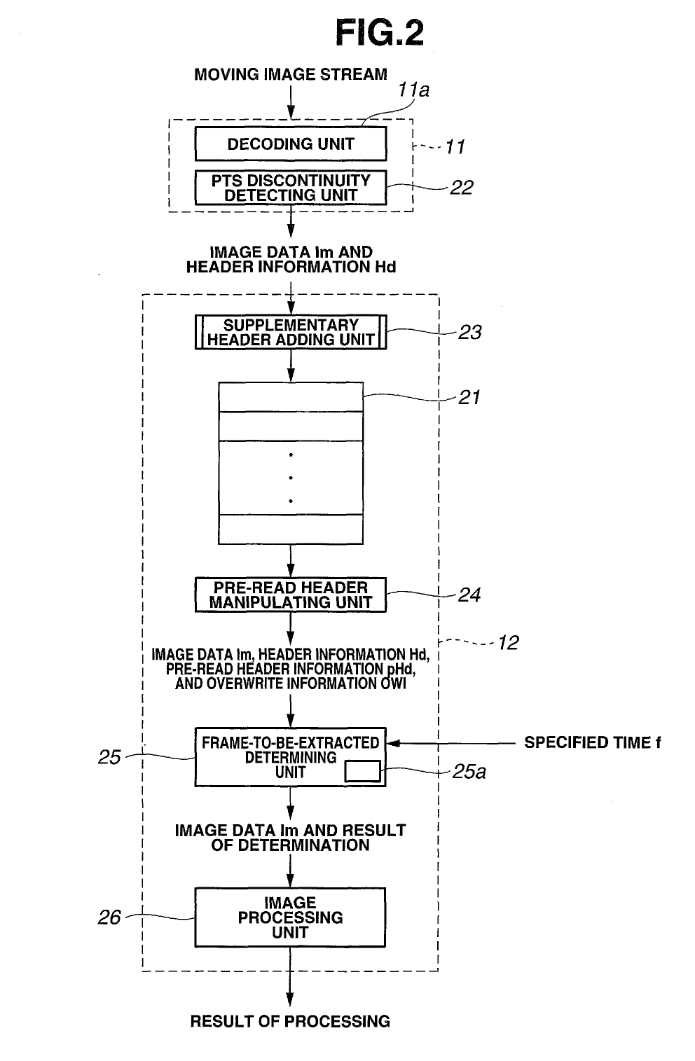

FIG. 2 is a diagram illustrating a configuration of the image processing apparatus and a flow of image processing according to the present embodiment.

The decoder 11 includes a decoding unit 11a and a PTS (Presentation Time Stamp) discontinuity detecting unit 22, which is a discontinuity detecting unit. The DSP 12 includes, in addition to the FIFO 21, a supplementary header adding unit 23, a pre-read header manipulating unit 24, a frame-to-be-extracted determining unit 25, and an image processing unit 26. The frame-to-be-extracted determining unit 25 includes an elapsed time accumulating register 25a. The FIFO 21, the supplementary header adding unit 23, and the pre-read header manipulating unit 24 constitute a FIFO unit.

A stream is first decoded by the decoding unit 11a in the decoder 11. The decoder 11 decodes the stream to generate image data Im of each frame and time information associated with the frame and outputs the image data Im of the frame and header information Hd including the time information to the DSP 12.

In the DSP 12, the supplementary header adding unit 23 generates supplementary header information Shd based on the header information Hd inputted into the DSP 12.

The supplementary header adding unit 23 stores the image data Im, the header information Hd, and the supplementary header information Shd in the FIFO 21 as frame-by-frame data. Specifically, the FIFO 21 stores the data in each FIFO block which is an internal memory area as data relating to one frame.

The FIFO 21 outputs data in the same order in which the data were inputted, that is, the first in is the first out. When an attempt is made to input data, that is, push data into the FIFO 21 but the array of the FIFO blocks in the FIFO 21 is full, data input in the last FIFO block, that is, the data in the end FIFO block is overwritten with the data to store the data.

The pre-read header manipulating unit 24 reads supplementary header information Shd and pre-read header information pHd which will be described later from the FIFO 21 performs a required manipulation of the pre-read header information pHd on the basis of the read data, and generates overwrite information OWI. The pre-read header manipulating unit 24 fetches image data Im, header information Hd, pre-read header information pHd, and overwrite information OWI and provides these items of information to the frame-to-be-extracted determining unit 25.

The frame-to-be-extracted determining unit 25, which is a frame-to-be-processed determining unit, reads data from the pre-read header manipulating unit 24, calculates the time that has elapsed from the start of the stream, as will be described later, and determines on the basis of inputted specified time f whether the read frame is a frame to which image processing is to be applied or not, that is, whether the read frame is a frame to be extracted. For example, the frame-to-be-extracted determining unit 25 adds determination result data including information indicating whether a frame is to be extracted or not to the image data of the frame and outputs the image data with the added determination result data.

The image processing unit 26 applies predetermined image processing only to frames to be extracted and outputs data resulting from the image processing to the CPU 13, the HDD, or other component. Specifically, the image processing unit 26 in the DSP 12 applies the predetermined image processing to the image in a frame that is determined by the frame-to-be-extracted determining unit 25 to be a frame to which the image processing is to be applied, and outputs the result of the image processing.

The predetermined image processing may be stored in the ROM 14 as a program and read and executed by the CPU 13 to output the result of the processing.

Configurations and functions of the components will be described below. (The decoder and the discontinuity detecting unit included in the decoder)

The decoder 11 decodes a stream and outputs image data Im of frames and header information Hd including time information associated with the image data Im that have resulted from the decoding to the FIFO 21. The time information includes a PTS (Presentation Time Stamp), a frame rate, and a discontinuity flag. The PTS and the frame rate are information originally contained in the stream.

In the present embodiment, the PTS is data associated with a frame of moving image data as a reference for determining regular intervals. The PTS is time data specifying the timing of displaying a moving image and corresponds to a time instant in playback time. Since the PTS is a value embedded in a moving image stream, the PTS is not affected by the timing of decoding or image processing. Even if an error occurs in a stream, a correct PTS can be obtained from a subsequent stream and therefore the error does not affect the determination as to whether a frame is to be extracted or not. Since the PTS is also added to audio data contained in the stream, the moving image data can be associated with the audio data. In the present embodiment, a frame to which image processing is to be applied is selected at regular intervals based on the PTS. However, the PTS does not necessarily increase in regular intervals. When a discontinuous point is encountered in a stream, the PTS can decrease, or greatly increase. Processing is performed so that such variations can be accommodated.

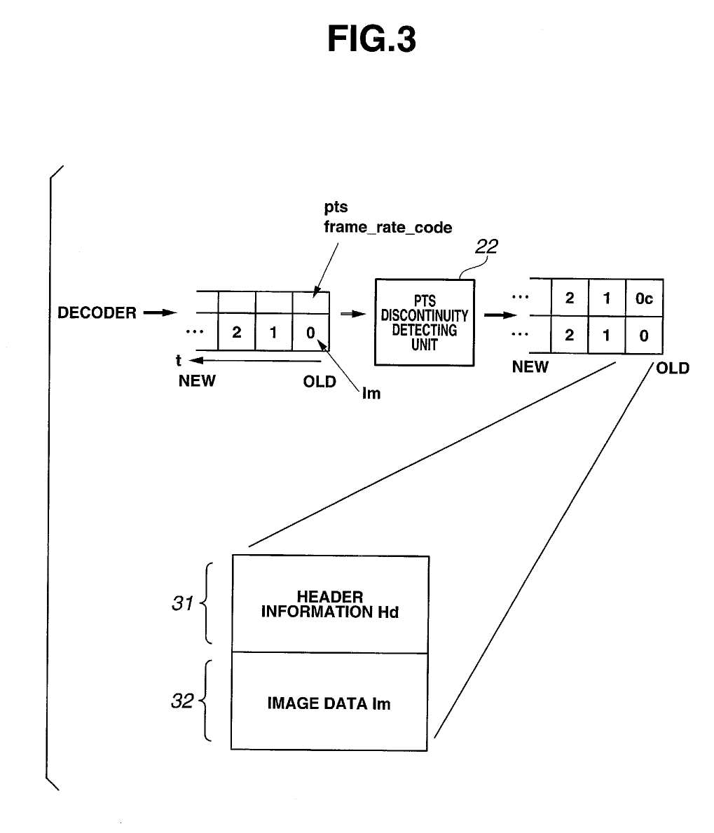

FIG. 3 is a diagram illustrating a configuration of data outputted from the decoder 11. As illustrated in FIG. 3, data decoded by the decoder 11 includes image data Im, a PTS, and a frame rate. The PTS discontinuity detecting unit 22 detects discontinuity on the basis of PTS information which is playback time data and at the same time generates and inserts an expediential frame indicating the discontinuity to the frame-to-be-extracted determining unit 25 (the frame is called dummy frame herein since the frame is not contained in the stream). Each frame of data outputted from the PTS discontinuity detecting unit 22 includes a header section 31 containing header information Hd and an image section 32 containing image data Im. Processing by the PTS discontinuity detecting unit 22 will be described later.

The header section 31 contains header information Hd including a PTS (pts), a frame rate (frame_rate_code), and a plurality of discontinuity flags. The plurality of discontinuity flags are: a flag indicating existence of a stream end (STE) (is_streamend), a flag indicating existence of a sequence end (SQE) (is_sequence_end), and a flag indicating existence of a stream change (STC) (is_stream_change). The flags will be described later.

The PTS indicates time at which the frame is to be displayed and is a value embedded in a stream at regular intervals. In MPEG2, for example, the PTS can take a value in the range of [0, 2³³−1]. When the PTS reaches 2³³−1 or larger, the PTS returns to 0 (zero). The time is represented in units of 90 kHz and the value increases by 90000 in 1 second. The PTS at the start of a stream can take any value, and it is generally not 0 (zero). The PTS and the frame rate are usually contained in each frame, but the PTS is not necessarily contained in every frame. If no PTS is contained in a frame, the decoder 11 generates the PTS by interpolation.

The frame rate is a value (expressed in frames per second (fps)) indicating the number of times per unit time that a full screen picture is updated during moving image playback, and is embedded in a stream. The time between the display of a frame and the display of a next frame in a moving image is typically 1/F seconds, where F is the frame rate. The PTS typically increases by 90000/F per frame.

The plurality of discontinuity flags are not contained in a stream; the discontinuity flags are generated by the PTS discontinuity detecting unit 22 when the PTS discontinuity detecting unit 22 detects a discontinuity of PTS. The discontinuity flags are additional information indicating the end of decoding or a discontinuity in a moving image when detected in the course of decoding, to the DSP 12.

The term discontinuity as used herein means a point at which a frame has been lost due to an error in a stream or a boundary between two streams from different sources, rather than a discontinuity of a content contained in a moving image such as a scene change in a drama. A missing frame can be detected by detecting a decoding failure or the presence of discontinuity between PTSs (for example a significant difference from a value expected on the basis of the frame rate). The boundary between streams can be detected by detecting a change of basic information about a moving image such as image size or frame rate or the presence of discontinuity between PTSs.

The following discontinuity flags are defined herein: a flag t indicating existence of a stream end (STE) (is_stream_end), a flag e indicating existence of a sequence end (SQE) (is_sequence_end), and a flag c indicating existence of a stream change (STC) (is_stream_change).

The stream end flag t indicates the end of a stream. When the PTS discontinuity detecting unit 22 detects a stream end (STE), the PTS discontinuity detecting unit 22 generates a dummy frame, which is an invalid frame, appends the dummy frame to a last valid frame, and adds a sequence end flag t to header information of the dummy frame. Thus, the PTS discontinuity detecting unit 22 constitutes a dummy frame adding unit configured to add a dummy frame.

The sequence end flag e indicates a discontinuity point in a stream. When the PTS discontinuity detecting unit 22 detects a sequence end (SQE), the PTS discontinuity detecting unit 22 generates a dummy frame, appends the dummy frame to the frame immediately preceding the discontinuity point, and adds a sequence end flag e to header information of the dummy frame.

The stream change flag c indicates a stream start point or a stream change point (the first valid frame after a discontinuity point). When the PTS discontinuity detecting unit 22 detects a stream change (STC), the PTS discontinuity detecting unit 22 adds a stream change flag c to the header information of the first valid frame after the discontinuity point.

### (Operation of the Discontinuity Detecting Unit)

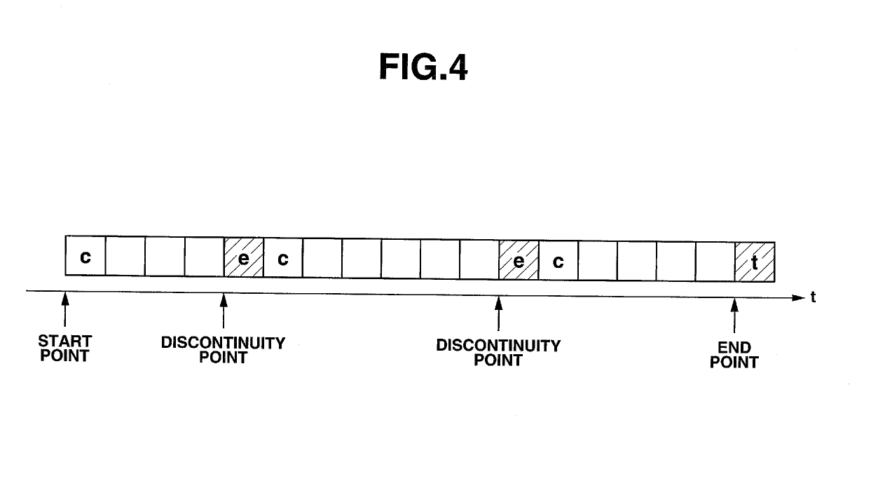

FIG. 4 is a diagram illustrating an example of how the PTS discontinuity detecting unit 22 adds the discontinuity flags and the dummy frames described above.

Since a frame at the start point of a stream is the first valid frame, a stream change flag c is added to the header information of the frame as illustrated in FIG. 4. When subsequently a discontinuity point is detected, a dummy frame is inserted at the discontinuity point and a stream change flag c is added to the header information of the first valid frame after the discontinuity point. A shaded frame in FIG. 4 is a dummy frame added, or inserted.

Likewise, when another discontinuity point is detected, a dummy frame is inserted and a stream change flag c is added to the header information of the first valid frame after the discontinuity point.

When the end point of the stream is detected, a dummy frame is appended to the last frame and a stream end flag t is added to the header information of the dummy frame.

The PTS discontinuity detecting unit 22 detects a discontinuity between frames in a stream. When the PTS discontinuity detecting unit 22 detects a discontinuity between frames in a stream, the PTS discontinuity detecting unit 22 adds a flag which is predetermined discontinuity information indicating the existence of the discontinuity and outputs the image data and header information with the added flag of the frame.

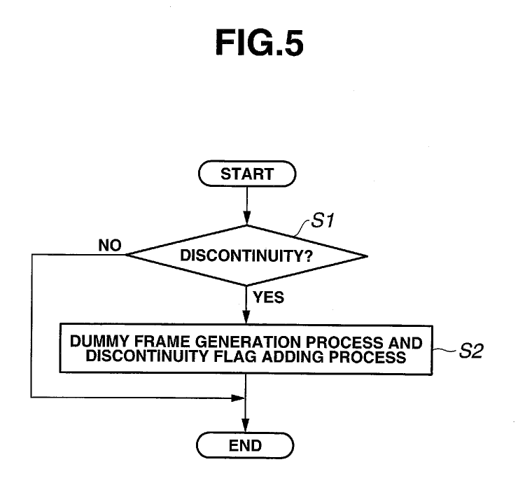

A flow of processing by the PTS discontinuity detecting unit 22 will be described. FIG. 5 is a flowchart illustrating an exemplary flow of processing by the PTS discontinuity detecting unit 22. The PTS discontinuity detecting unit 22 may be implemented by circuitry or a software program. The processing illustrated in FIG. 5 is performed by the circuitry or the program.

As illustrated in FIG. 5, the PTS discontinuity detecting unit 22 first monitors decoded frames to determine whether there is a discontinuity or not (step S1). The determination is made on the basis of whether the difference between the PTSs of consecutive frames is greater than or equal to a predetermined value.

If the difference between the PTSs of consecutive frames is greater than or equal to the predetermined value, the determination at step S1 will be YES and the PTS discontinuity detecting unit 22 performs the processing to insert a dummy frame and the processing to add a discontinuity flag to the header section as described above (step S2). Specifically, in the case of a stream end (STE) or a sequence end (SQE), a dummy frame is inserted or added. In addition, in the case of a stream end (STE), the PTS discontinuity detecting unit 22 adds a stream end flag t to the time information of the dummy frame appended after the last valid frame; in the case of the sequence end (SQE), the PTS discontinuity detecting unit 22 adds a sequence end flag e to the time information of the inserted dummy frame. In the case of a stream change (STC), the PTS discontinuity detecting unit 22 adds a stream change flag c to the time information of the first valid frame at the stream start point or the stream change point.

### (FIFO Unit)

A configuration and an operation of the FIFO unit including the FIFO 21, the supplementary header adding unit 23, and the pre-read header manipulating unit 24 will be described below.

### (FIFO)

The FIFO 21 includes a data holding section for holding frame data as sequence data. The FIFO 21 associates image data Im and header information Hd from the PTS discontinuity detecting unit 22 with frames and stores the same into an internal FIFO blocks.

The data holding section of the FIFO 21 consists of multiple FIFO blocks. One frame of data inputted, or pushed, from the decoder 11 is stored in each FIFO block. The frame data stored includes header information Hd including time information, and image data Im. Each FIFO block is configured to be able to store supplementary header information Shd concerning each frame, as mentioned above.

Data in the FIFO blocks of the FIFO 21 are outputted, or popped, in response to a pop request from the frame-to-be-extracted determining unit 25 in the order in which the data were stored.

In the FIFO memory used in the present embodiment, data is inputted and outputted in such a manner that processing of frames can be skipped in order to ensure real-time processing performance without loosing time information required for determining mining frames to be extracted. Specifically, the decoding unit 11a, which is a moving image decoder, decodes a stream in real time and writes header information Hd including time information, and image data Im into the FIFO 21. When processing by the image processing unit is lagging and the FIFO 21 is full, a frame is automatically overwritten. However, even though an overwrite occurs, the frame-to-be-extracted determining unit 25 can take out required time information from the FIFO 21 as will be described later. Accordingly, even when processing of a frame is skipped in order to ensure real time processing performance, the result of the subsequent processing for determining frames to be extracted is not affected.

The image processing apparatus according to the present embodiment ensures that a frame to be extracted is uniquely determined even when image processing is suspended for some reasons and then the image processing is resumed with a portion of stream already processed being skipped. That is, the same frame will be determined to be extracted as that would result if the processing was performed from the start of the stream without suspension.

(Push into the FIFO)

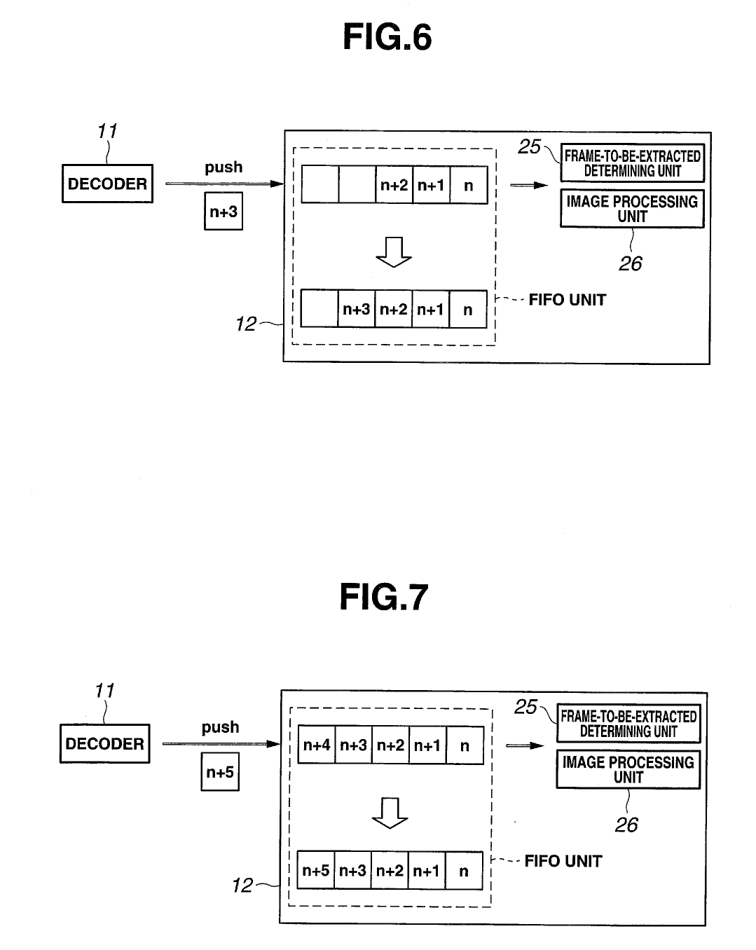

FIG. 6 is a diagram illustrating data pushing into the FIFO 21 when there is an available FIFO block in the FIFO 21. As illustrated in FIG. 6, frame data (n+3) is pushed into an available FIFO block. FIG. 7 is a diagram illustrating data pushing into the FIFO 21 when the FIFO 21 is full. As illustrated in FIG. 7, frame data (n+5) is pushed into the FIFO 21 to overwrite frame data (n+4) stored in the last FIFO block since no FIFO block is available. In this way, when there is an available FIFO block in the FIFO 21, frame data is sequentially pushed into the FIFO 21; when the FIFO 21 is full, only the last pushed frame data is overwritten.

### (Structure of Data in the FIFO)

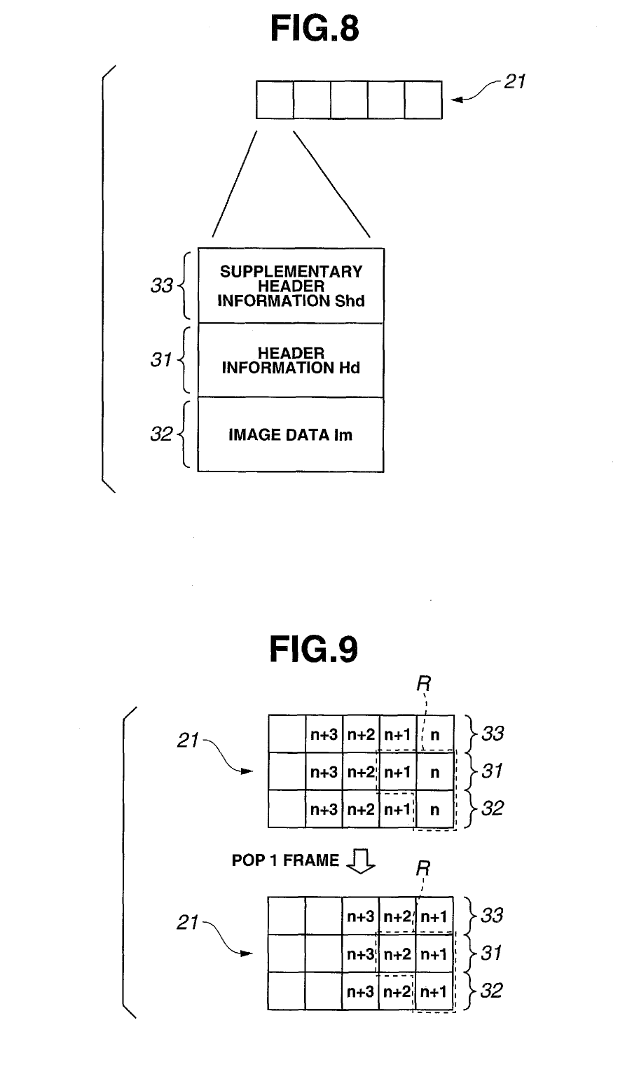

FIG. 8 is a diagram illustrating a structure of data stored in the FIFO 21. As illustrated in FIG. 8, data stored in each FIFO block of the FIFO 21 includes a header section 31 containing header information Hd, an image section 32 containing image data Im, and a supplementary header section 33 containing supplementary header information Shd. The header section 31 contains a PTS, which is time information concerning the frame, a frame rate, and a discontinuity flag generated by the PTS discontinuity detecting unit 22. The image section 32 contains image data Im, which is a frame image. The supplementary header section 33 contains information added by the supplementary header adding unit 23, which will be described later, to each frame of data inputted in the FIFO 21.

(Pop from the FIFO)

Data read from the FIFO 21 includes pre-read header information pHd manipulated by the pre-read header manipulating unit 24, which will be described later, and overwrite information OWI generated by the pre-read header manipulating unit 24, in addition to image data Im and header information Hd of each frame.

On the basis of the header information Hd, the pre-read header information pHd and the overwrite information OWI outputted from the pre-read header manipulating unit 24, the frame-to-be-extracted determining unit 25 determines whether to extract or skip a current frame popped from the FIFO 21. The frame-to-be-extracted determining unit 25 requires the pre-read header information pHd including time information of a next frame for making the determination.

Specifically, in the image processing apparatus 1 of the present embodiment, when data stored in the FIFO 21 is popped for image processing such as face detection processing, the pre-read header manipulating unit 24 reads the header section 31 from the second block in addition to the header section 31 and image section 32 in the first block of the FIFO 21. While the header section 31 in the second block in itself is information to be read next time, the header section 31 in the second block is read in advance when the header section 31 in the first block is read.

FIG. 9 is a diagram illustrating a range of data read out, or popped, from the FIFO 21. As illustrated in FIG. 9, when frame data with frame number n (where n is an integer) (hereinafter frame data with frame number n is referred to as frame data n), the header section 31 of frame data (n+1) is also read as pre-read header information pHd together with the header section 31 and image data section 32 of frame data n. Data in a read range R indicated by dashed lines in FIG. 9 is read out.

When next frame data (n+1) is read out after the frame has been popped, the header section 31 of frame data (n+2) is read out as pre-read header information pHd together with the header section 31 and the image data section 32 of frame data (n+1). When frame data is read from the FIFO 21, overwrite information OWI is added as stated earlier.

When data is read from the FIFO 21 by popping, only the frame data in the first FIFO block of the FIFO 21 is removed and the data in the second data section 31, which is the pre-read header section, is read but is left in the FIFO 21.

Thus, while data is read from the FIFO 21 when data is in the FIFO 21, data can be popped from the FIFO 21 only when data is stored in more than one FIFO block of the FIFO 21. When data is stored only in one FIFO block, the data is not permitted to be popped until next data is pushed into the FIFO 21.

In this way, by reading the header section of next frame data (that is, the pre-read header section) along with current data to be read, the frame-to-be-extracted determining unit 25 can readily obtain the difference in time information between frame images inputted into the frame-to-be-extracted determining unit 25. Accordingly, processing in the frame-to-be-extracted determining unit 25 is simplified.

In the following description, the function of reading the header section 31 of next data along with current frame data when the current frame data is read from the FIFO 21 is referred to as the time pre-reading function.

### (Discontinuity Flag and Time Information)

The following is description of processing for preventing a discontinuity flag and time information associated with the discontinuity flag from being lost when frame data in the FIFO 21 is overwritten, thereby preventing the influence of the overwrite on the determination at the frame-to-be-extracted determining unit 25.

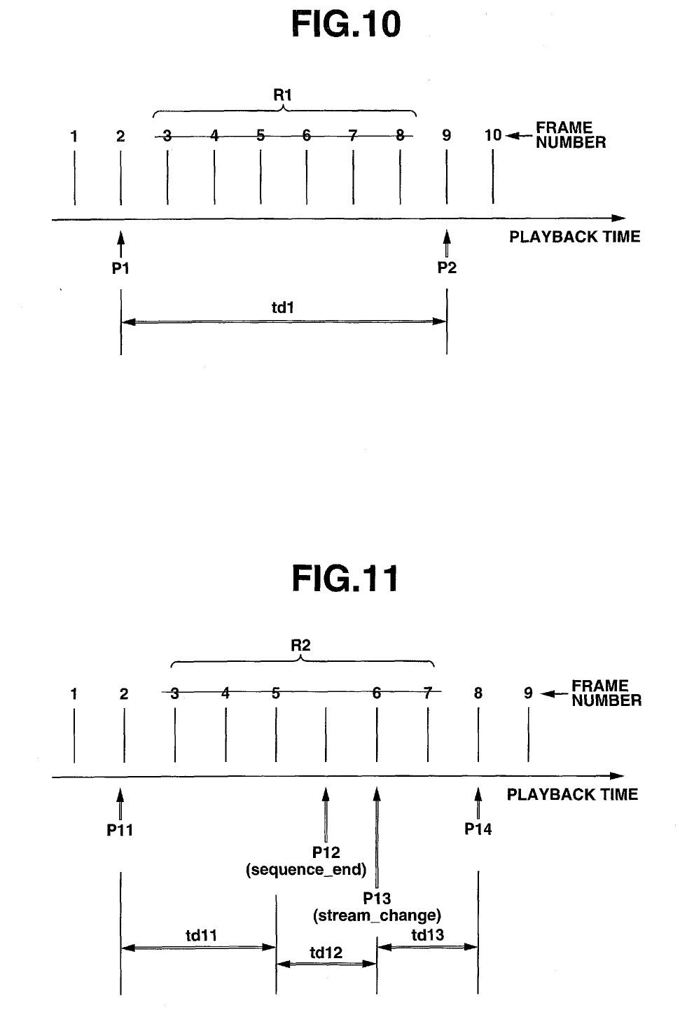

A case will be described first in which continuous frame data, that is, frame data without a discontinuity, has been pushed into the FIFO 21 and a portion of the frame data has been overwritten and lost. FIG. 10 is a diagram illustrating a case in which frame data without a discontinuity has been pushed into the FIFO 21 and a portion of the frame data has been overwritten and lost. As illustrated in FIG. 10, frame data is inputted into the FIFO 21 in sequence as playback time passes. In FIG. 10, frame data with frame numbers 1 to 10 have been inputted in sequence. However, intermediate frame data with frame numbers 3 to 8 in range R1 has been overwritten and lost because the FIFO 21 has been full. The PTSs of frame data have been obtained 2 until frame data 2 indicated by P1, and the PTSs of frame data have been obtained 9 after frame data 9 indicated by P2.

In the case in FIG. 10, by subtracting the value of the PTS of frame data 2, indicated by P1, obtained immediately before frame data 9 from the value of the PTS of frame data 9, indicated by P2, which has not been overwritten and therefore obtained, an increase or a difference td1 of elapsed time can be obtained. In this way, the same elapsed time that would be provided if the overwrite had not occurred can be calculated.

A case will be described next in which discontinuous frame data has been pushed into FIFO 21 and a portion of the frame data has been overwritten and lost. FIG. 11 is a diagram illustrating a case in which discontinuous frame data has been pushed into the FIFO 21 and a portion of the frame data has been overwritten and lost.

As illustrated in FIG. 11, frame data is inputted in sequence into the FIFO 21 as playback time passes. In FIG. 11, frame data with frame numbers 1 to 9 have been inputted in sequence. However, intermediate frame data 3 to 7 have been overwritten and lost because the FIFO 21 has been full. Furthermore, a sequence end (SQE) is at the position indicated by P12 between frame data 5 and 6.

Since there is a discontinuity among the plurality of overwritten frame data as illustrated in FIG. 11, the PTS has significantly changed between frame data 5 and 6. The difference in PTS between frame data 5 and 6 is so large that it is improper to treat the difference as elapsed time for one frame. It is even more improper to use the difference in PTS between frame data 2 and 8 as the elapsed time for frame number 8.

Here, the elapsed time is calculated as the sum of the following three values.

Value of a first difference (td11): Difference in PTS between frame data at P11 (frame data 2 in FIG. 11), the PTS of which has been obtained, and the frame data (frame data 5 in FIG. 11) immediately preceding the sequence end (SQE) at discontinuity point P12

Value of a second difference (td12): Elapsed time for one frame calculated from the frame rate of the frame data immediately preceding the discontinuity at P12

Value of a third difference (td13): Difference in PTS between the first frame, indicated by P13 (frame data 6 in FIG. 11), where processing has been resumed after the discontinuity was encountered and the frame data, indicated by P14 (frame data 8 in FIG. 11), the PTS of which has been obtained

In order to calculate the three values, the following items of information need to be retained without loss.

First information (I1): Discontinuity flags (e, c and t)

Second information (I2): PTS and frame rate immediately preceding a sequence end (SQE) (sequence_end)

Third information (I3): PTS at stream change (STC) (stream_change)

The first information, discontinuity flags, are the discontinuity flags e, c and t described above. The second information, the PTS and the frame rate immediately preceding the sequence end (SQE), is the PTS and frame rate of frame data 5 in FIG. 11, for example. The third information, the PTS at a stream change (STC), is the PTS of frame data 6 in FIG. 11, for example.

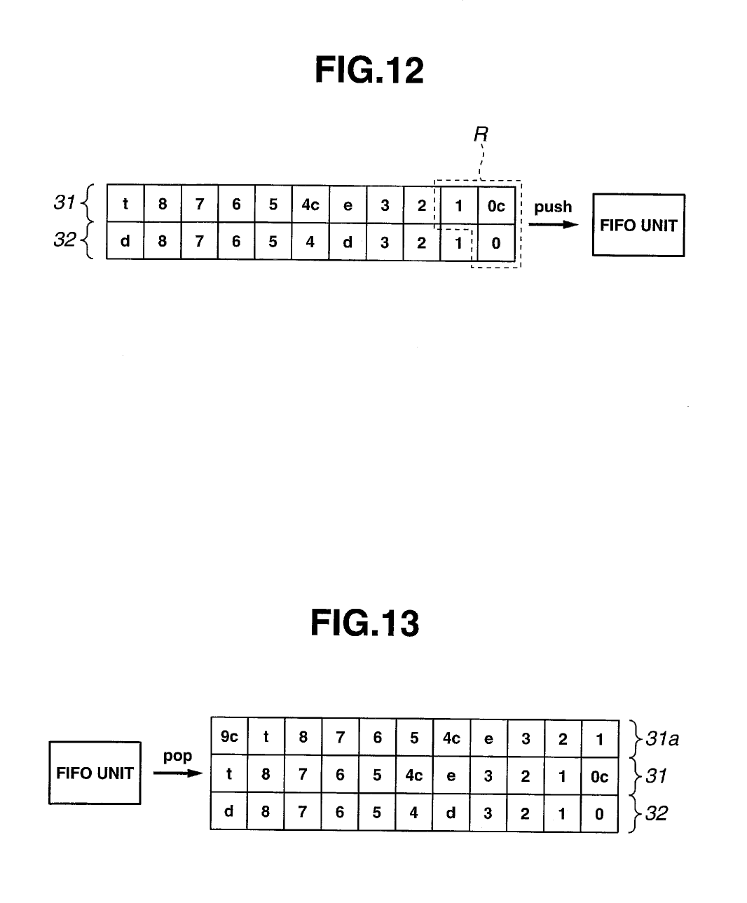

Referring to FIGS. 12 through 15, how the discontinuity flags are retained will be described. FIG. 12 is a diagram illustrating a header section 31 and an image section 32 of a frame data sequence being pushed into the FIFO 21. FIG. 13 is a diagram illustrating a header section 31, an image section 32, and a pre-read header section 31a popped when the frame data sequence illustrated in FIG. 12 has been pushed into the FIFO 21 without having been overwritten.

Assumption here is that the frame data sequence including the header section 31 and the image section 32 is pushed from the decoder 11 into the FIFO 21 in ascending order of frame numbers as illustrated in FIG. 12. In FIG. 12, a discontinuity point is between frames 3 and 4 and frame 8 is at the stream end (STE).

When the PTS discontinuity detecting unit 22 detects a sequence end (SQE), the PTS discontinuity detecting unit 22 generates a frame of dummy image data d (dummy frame), appends the dummy frame after the frame immediately preceding the discontinuity point, and adds a sequence end flag e to time information in the header information Hd of the dummy frame, as described above. When the PTS discontinuity detecting unit 22 detects a stream change (STC), the PTS discontinuity detecting unit 22 adds a stream change flag c to the time information of the first valid frame after the discontinuity point. Consequently, the frame data of the dummy frame d is inserted between frame data 3 and 4, the sequence end flag e is added to the header section 31 of the dummy frame, and the stream change flag c is added to the header section 31 of frame data 4.

When the frame data illustrated in FIG. 12 is inputted into the FIFO 21 without overwriting, the data in the read range R, including the pre-read header section 31a, is read out from the FIFO 21 as illustrated in FIG. 13. However, since there is not a pre-read header section for the last frame data (the stream end (STE) succeeding frame 8 in FIG. 13), a header with a stream change flag c (9c in FIG. 13) is generated and added for expediency.

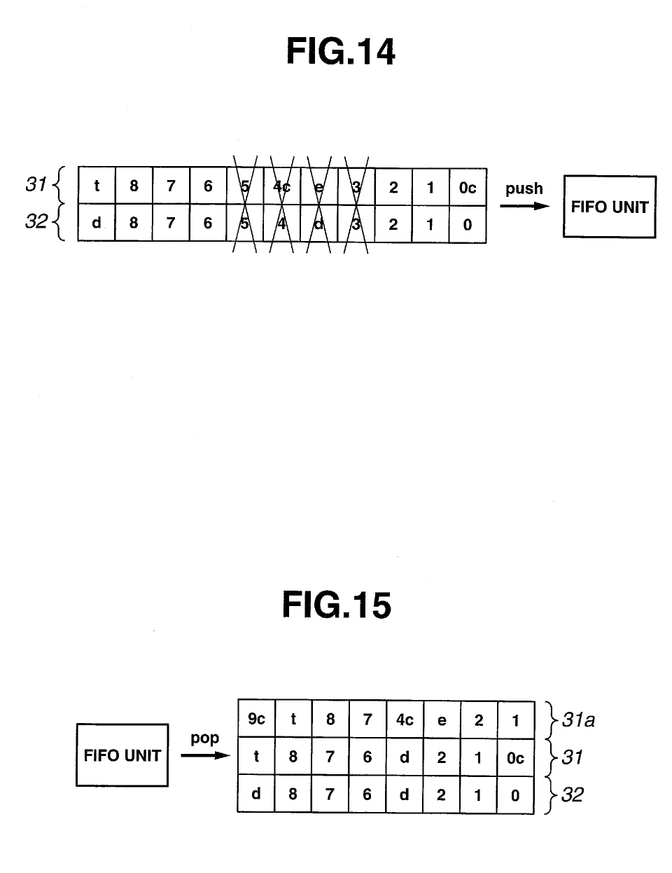

A case will be described next in which multiple frames of data across a discontinuity point in such a frame data sequence has been overwritten in the FIFO 21. FIG. 14 is a diagram illustrating a frame data sequence including discontinuities and being pushed into the FIFO 21. In FIG. 14, the crosses indicate that frame data 3 to 5 have been overwritten in the FIFO 21 and lost. FIG. 15 is a diagram illustrating a header section 31, an image section 32 and a pre-read header section 31a popped from the FIFO 21 when multiple frames of data in the frame data sequence in FIG. 14 have been overwritten and lost.

As illustrated in FIG. 15, the range of data R popped from the FIFO 21 is the same as that in FIG. 13. However, the data in the pre-read header section 13a is manipulated when the data is popped from the FIFO 21, as will be described later. Furthermore, frame data is generated and inserted as necessary. The manipulation and insertion are made in order to prevent the above-described first to third items of information (I1, 12 and 13) required for calculating the above-described three differences td11, td12 and td13 from being lost. The alteration of data in the pre-read header section 31 and the insertion of frame data will be described later.

In brief, the pre-read header is manipulated and frame data is inserted so that, even though frame data 3 through 5 have been overwritten in the FIFO 21, frame data having the pre-read header section 31a with the overwritten sequence end flag e and stream change flag c is popped from the FIFO 21 illustrated in FIG. 15.

When the frame data is inserted, a frame image, which typically has a large amount of data, is not replaced or the like but is treated as an invalid image and a flag information indicating that the frame is an inserted frame (that the image is invalid) is added and outputted with the frame. In the example in FIG. 15, the data in the header section 31 and the image section 32 corresponding to the pre-read header section 31a (4c in FIG. 15) of the frame data 4 are overwritten and lost and are dummy data d.

Time information is also recovered and contained in the pre-read header sections 31a recovered by the replacement or the like. The pre-read header section 31a with a sequence end flag e (e in FIG. 15) contains the PTS and the frame rate of the immediately preceding frame data (frame 3 in FIG. 15). The pre-read header section 31a with a stream change flag c (4c in FIG. 15) contains the PTS of the frame (frame 4).

This function is referred to as the discontinuity information loss prevention function. The function is intended to prevent discontinuity flags and time information associated with the discontinuity flags from being lost, thereby preventing a data overwrite from affecting the result of determination by the frame-to-be-extracted determining unit 25.

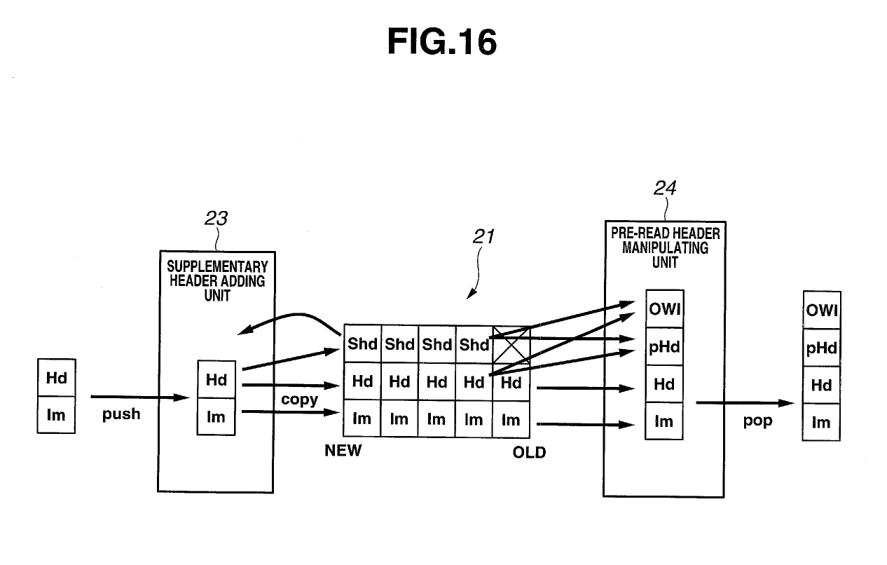

FIG. 16 is a diagram illustrating operation of pushing data into and popping data from the FIFO 21. The supplementary header adding unit 23 stores image data Im and header information Hd including time information of each frame into a image data Im memory area and a header information Hd memory area of one FIFO block section of the FIFO 21 and also stores supplementary header information Shd into a supplementary header information Shd memory area. The supplementary header adding unit 23 reads and alters the supplementary header information Shd of the last FIFO block as necessary. Therefore, the FIFO 21 is configured so that data in the last FIFO block can be referred to and altered as well as that data can be pushed into the last FIFO block.

Image data Im, header information Hd and supplementary header information Shd inputted into the FIFO 21 on a first-in-first-out basis are read by the pre-read header manipulating unit 24 in the order in which the data were inputted. As stated above, the pre-read header manipulating unit 24 generates overwrite information OWI and outputs pre-read header information pHd, header information Hd and image data Im when data is popped.

### (Configuration of the Supplementary Header)

A configuration of supplementary header information Shd will be described. Supplementary header information Shd includes information indicating a overwrite count (overwrite_count) OWC, a post stream change overwrite count (STC) (post_stream_change_overwrite_count) C1, a stream change count (stream_change_count) C2, a stream change PTS (stream change_pts), a stream change frame rate (stream_change_framerate), a stream end count (stream end count) C3, a stream end PTS (stream end pts), a stream end frame rate (stream_end_frame_rate), a sequence end count (sequence_end_count) C4, a sequence end PTS (sequence_end_pts), and a sequence end frame rate (sequence_end_framerate).

The over write count OWC indicates how many times the last FIFO block has been overwritten.

The post stream change overwrite count C1 indicates the number of overwrites after a stream change (STC) has occurred in the FIFO block.

The stream change count C2 indicates whether a stream change (STC) has occurred or not if an overwrite has not occurred, or indicates the number of stream changes (STC) in overwritten data if an overwrite has occurred.

The stream change PTS indicates the PTS of a stored frame if an overwrite has not occurred, or indicates the PTS at which the first stream change (STC) has occurred in the overwritten frame if an overwrite has occurred.

The stream change frame rate indicates the frame rate of a stored frame if an overwrite has not occurred, or indicates the frame rate at the time the first stream change (STC) has occurred in overwritten data if an overwrite has occurred.

The stream end count C3 indicates whether a stream end (STE) has been encountered if an overwrite has not occurred, or indicates the number of stream ends (STE) in overwritten data if an overwrite has occurred.

The stream end PTS indicates the PTS of a stored frame if an overwrite has not occurred, or indicates the PTS immediately before the first stream end (STE) in overwritten data if an overwrite has occurred.

The stream end frame rate indicates the frame rate of a stored frame if an overwrite has not occurred, or indicates the frame rate immediately before the first stream end (STE) in overwritten data if an overwrite has occurred.

The sequence end count C4 indicates whether a sequence end (SQE) has been encountered if an overwrite has not occurred, or indicates the number of sequence ends (SQE) in overwritten data if an overwrite has occurred.

The sequence end PTS indicates the PTS of a stored frame if an overwrite has not occurred, or indicates the PTS immediately before the first sequence end (SQE) in overwritten data if an overwrite has occurred.

The sequence end frame rate indicates the frame rate of a stored frame if an overwrite has not occurred, or indicates the frame rate immediately before the first sequence end (SQE) in overwritten data if an overwrite has occurred.

As described above, the supplementary header adding unit 23 as a supplementary header generating unit generates supplementary header information including at least the overwrite count OWC, the post stream change overwrite count C1, information indicating the presence or absence of a stream change, information indicating the presence or absence of a stream end, information indicating the presence or absence of a sequence end, the PTS at the time a stream change has occurred, the PTS immediately before a sequence end, and the frame rate immediately before a sequence end on the basis of the stream end flag t indicating a stream end, the sequence end flag e indicating a sequence end included in the stream, and the stream change flag c indicating a change of the stream.

While it is assumed here that each discontinuity flag is overwritten at most once in one FIFO block of the FIFO, multiple overwrites of one flag may be enabled by arranging internal information in arrays. When the number of multiple overwrites of the same flag exceeds the number of arrays, an error notification may be provided as additional information during fetch. Since there are usually many frames between discontinuity points in a stream, multiple overwrites of the same flag can only occur when a large number of overwrites have occurred or when processing an unusual stream in which discontinuous points appear in extremely short intervals. Therefore, the allowable number of overwrites does not need to be set to a large value.

Furthermore, when a normal frame (that is, a frame that is neither end nor discontinuous frame) has been overwritten, data is not inserted but the number of overwrites is outputted as additional information to indicate whether an overwrite has occurred or not to the output side (that is, the frame-to-be-extracted determining unit 25). When a frame that has overwritten a normal frame is a discontinuity point, the time instance of the immediately preceding frame that is contained in internal information of a FIFO block is placed in header information Hd and outputted.

### (Generation of the Supplementary Header)

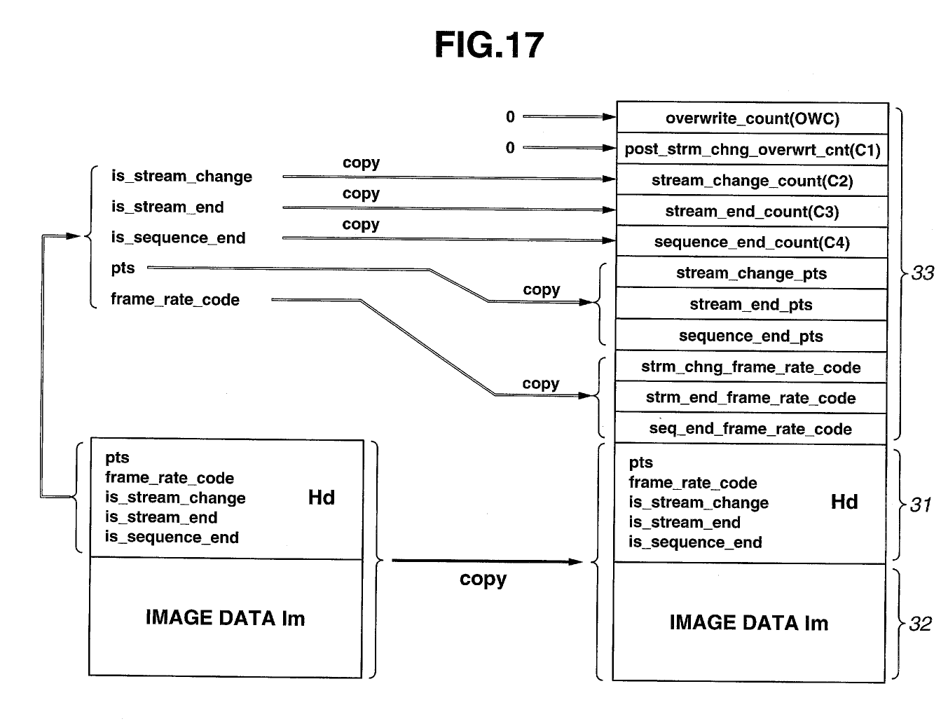

FIG. 17 is a diagram illustrating an operation of the supplementary header adding unit 23 to generate supplementary header information Shd together with image data Im and header information lid and write the supplementary header information into a FIFO block of the FIFO 21 when there is an available FIFO block in the FIFO 21 (that is, the FIFO is not full).

### (When the FIFO is not Full)

As illustrated in FIG. 17, when there is an available FIFO block in the FIFO 21, the supplementary header adding unit 23 writes 0 (zero) in the overwrite count OWC and the post stream change overwrite count C1 of the supplementary header information Shd.

The supplementary header adding unit 23 copies the content of presence or absence of the stream change (is_stream_change) in inputted header information Hd to the stream change count C2, copies the content of presence or absence of the stream end (is_stream_end) to the stream end count C3, and copies the content of presence or absence of the sequence end (SCE) (is_sequence_end) to the sequence end count C4.

The supplementary header adding unit 23 also copies the content of the stream change PTS (pts) in the inputted header information Hd to the stream change PTS, the stream end PTS, and the sequence end PTS. The supplementary header adding unit 23 also copies the content of the frame rate in the inputted header information Hd to the stream change frame rate, the stream end frame rate, and the sequence end frame rate. In this way, the supplementary information Shd is updated.

The inputted header information Hd and image data Im are copied into a FIFO block without any manipulations.

Consequently, the supplementary information Shd, the header information Hd, and the image data Im is stored from the inputted header information Hd and the image data Im in the FIFO block in the FIFO 21 by the supplementary header adding unit 23 as illustrated in FIG. 17.

### Example

The operations will be described with respect to an example.

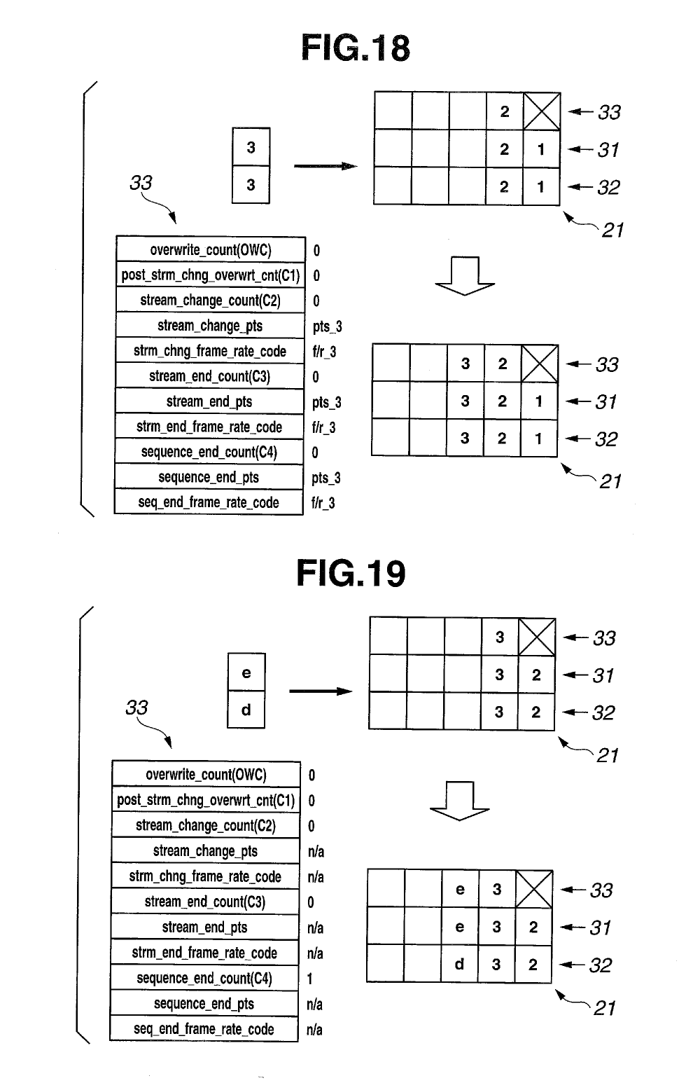

FIGS. 18 through 21 are diagrams illustrating data writing into the FIFO 21 when there is an available FIFO block in the FIFO 21. It is assumed in the example described below that frames 0 to 8 are inputted and a sequence end (SQE) is between intermediate frames 3 and 4. The lower left part of each diagram shows supplementary header information of the last block of the FIFO 21 after a frame has been pushed.

FIG. 18 illustrates that since only the data of frames 1 and 2 are held in the FIFO 21, the image data Im and header information Hd of frame 3, which is a normal frame, is stored in the FIFO 21 without any manipulations and header information Hd of frame 3 is held in the supplementary header section 33 without any manipulations. In the supplementary header section 33, the PTS of frame 3 (pts_3) is copied to the stream change PTS, the stream end PTS, and sequence end PTS, and the frame rate of frame 3 (f/r_3) is copied to the stream change frame rate, the stream end frame rate and the sequence end frame rate.

FIG. 19 illustrates that since only data of frames 2 and 3 are held in the FIFO 21, the image data d of dummy frame of the sequence end frame and the header information Hd of a sequence end (SQE) (including a sequence end flag e) are stored in the FIFO 21 without any manipulations and the sequence end flag e indicating the sequence end (SQE) is held in the supplementary header section 33. In the supplementary header section 33, invalid data (n/a) of the dummy frame is copied to the stream change PTS, the stream end PTS, and the sequence end PTS, and invalid dummy data (n/a) is copied to the, stream change frame rate, the stream end frame rate, and the sequence end frame rate.

The sequence end count C4 is set to “1” in supplementary header section 33.

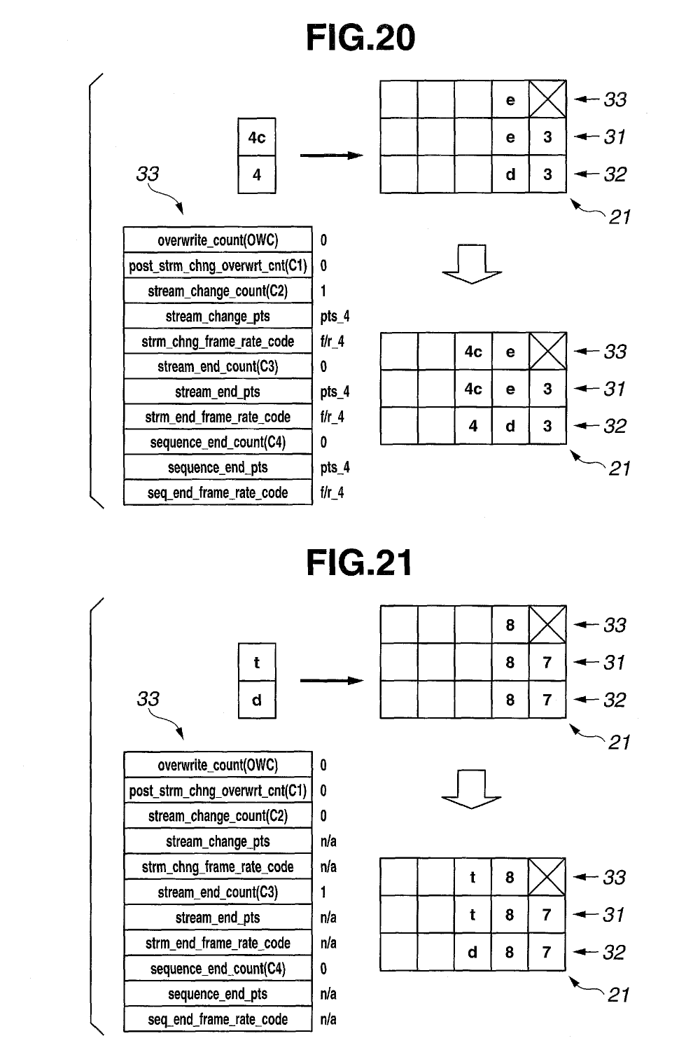

FIG. 20 illustrates that since only frame 3 and the sequence end frame are held in the FIFO 21, image data Im and header information Hd (including a stream change flag c) of the subsequent normal frame, that is, frame 4, are stored in the FIFO 21 without any manipulations and a stream change flag c indicating that a stream change (STC) is in frame 4 is held in the supplementary header section 33. In the supplementary header section 33, the PTS of frame 4 (pts_4) is copied to the stream change PTS, the stream end PTS and sequence end PTS and the frame rate of frame 4 (f/r_4) is also copied to the stream change frame rate, the stream end frame rate, and the sequence end frame rate.

The stream change count C2 is set to “1” in the supplementary header section 33.

FIG. 21 illustrates that since only frames 7 and 8 are held in the FIFO 21, image data Im of a dummy frame of the subsequent stream end frame and the header information Hd (including a stream end flag t) of the stream end (STE) are stored in the FIFO 21 without any manipulations and a stream end flag t indicting the stream end (STE) is held in the supplementary header section 33. In the supplementary header section 33, invalid data (n/a) of the stream end frame to be pushed is copied to the stream change PTS, the stream end PTS and sequence end PTS, and invalid data (n/a) is also copied to the stream change frame rate, the stream end frame rate, and the sequence end frame rate.

The stream end count C3 is set to “1” in the supplementary header information 33.

When there is an available FIFO block in the FIFO 21, data is generated and held in FIFO blocks as descried above.

### (When FIFO is Full)

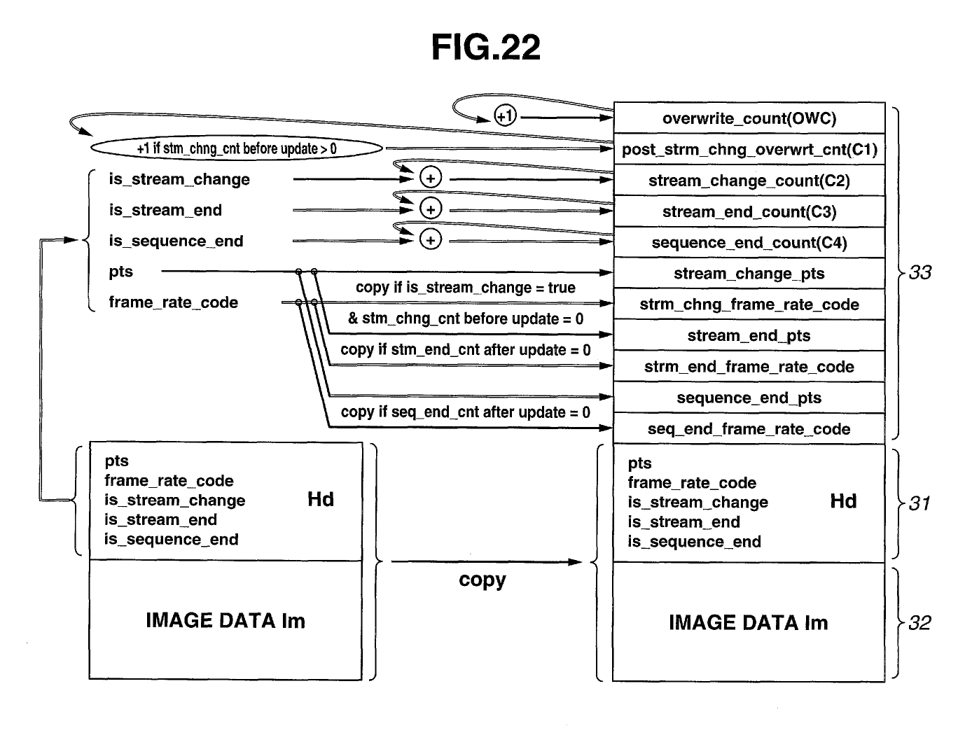

FIG. 22 is a diagram illustrating that when there is no available FIFO block in the FIFO 21, the supplementary header adding unit 23 generates supplementary header information Shd in addition to image data Im and header information Hd and writes the information into a FIFO block.

As illustrated in FIG. 22, when there is no available FIFO block in the FIFO 21, the supplementary header adding unit 23 increments the overwrite count OWC in the supplementary header information Shd every time an overwrite has occurred.

The supplementary header information Shd of the last FIFO block containing last inputted data or last overwritten data is referred to and, if the stream change count C2 in the supplementary header information Shd of the last FIFO block is not 0 (zero) (that is, a stream change flag c indicating occurrence of a stream change (STC) has been received previously), the post stream change overwrite count C1 is incremented by the supplementary header adding unit 23 every time an overwrite occurs.

The stream change count C2, the stream end count C3 and the sequence end count C4 are incremented every time a stream change flag c, a stream end flag t, and a sequence end flag e, respectively, are received.

When the stream change count C2 in the supplementary header information Shd of the last FIFO block is 0 (zero) and there is a stream change (STC), an inputted PTS value and an inputted frame rate value are copied to the stream change PTS and the stream change frame rate, respectively. When a first-time stream change (STC) is encountered, inputted data is copied to the stream change PTS and the stream change frame rate. That is, the PTS and frame rate of the frame in which a stream change has occurred for the first time are stored as the stream change PTS and the stream change frame rate, respectively.

When the stream end count C3 after an update is 0 (zero), an inputted PTS value and an inputted frame rate value are copied to the stream end PTS and the stream end frame rate, respectively. When a stream end (STE) has not been encountered, inputted data is copied to the stream end PTS and the stream end frame rate. That is, the PTS and frame rate of the latest frame among frames in which a stream end (STE) has not occurred (the PTS and frame rate immediately before a stream end) are stored as the stream end PTS and the stream end frame rate.

When the sequence end count C4 after an update is 0 (zero), an inputted PTS value and an inputted frame rate value are copied to the sequence end PTS and the sequence end frame rate, respectively, When a sequence end (SQE) has not been occurred, inputted data is copied to the sequence end PTS and the sequence end frame rate. That is, the PTS and frame rate of the latest frame among frames in which a sequence end (SQE) has not occurred (the PTS and frame rate immediately before a sequence end) are stored as the sequence end PTS and the sequence end frame rate.

In this way, the supplementary header information Shd is updated.

In particular, the supplementary header adding unit 23 continues to copy a PTS and a frame rate from header information Hd until a sequence end (e) is encountered to store the PTS immediately before the sequence end (e) and the frame rate (f/r) immediately before the sequence end (e). When the first stream change (c) occurred, the supplementary header adding unit 23 copies the PTS from the header information Hd to store the PTS of the time at which the stream change (c) occurred.

The inputted header information Hd and image data Im is directly overwritten in the last FIFO block.

### Example

The operations described above will be described with respect to an example.

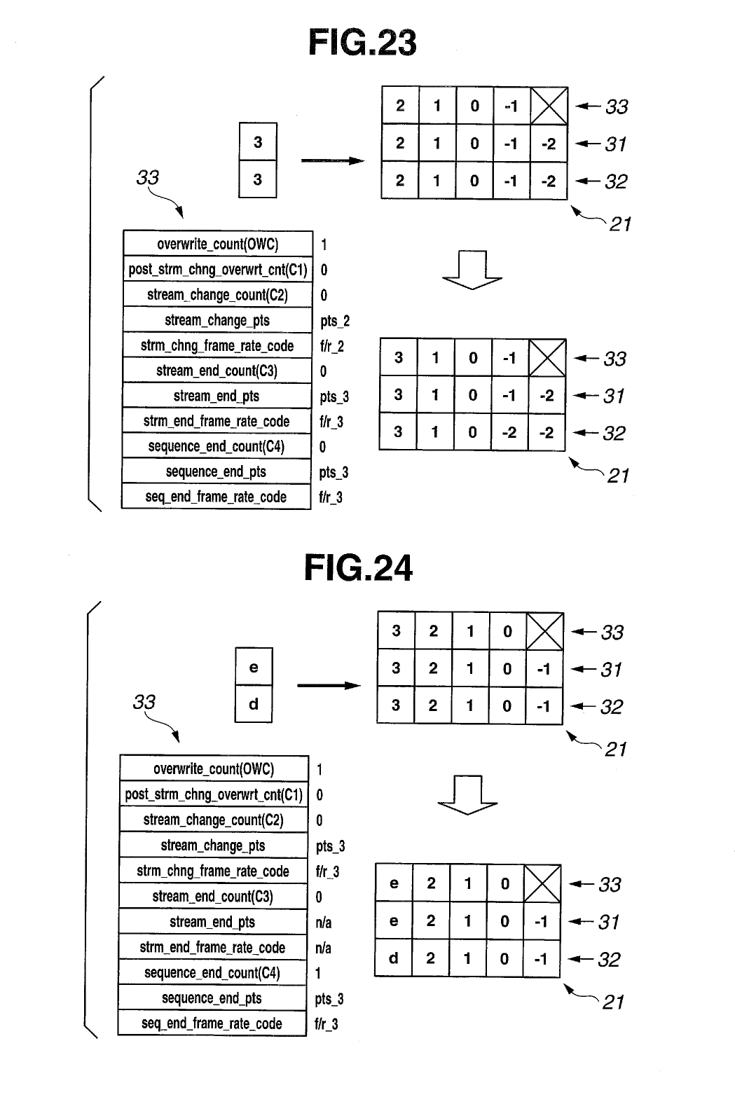

FIGS. 23 through 30 are diagrams illustrating data writing into the FIFO 21 when the FIFO 21 is full. Negative frame numbers contained in FIGS. 23 through 30 are used for convenience of explanation in order to make the frame numbers pushed the same as the corresponding numbers used in the description of the operations performed when there is an available FIFO block in the FIFO 21 (FIGS. 18 through 21). The lower left part of each drawing shows supplementary header information of the last FIFO block in the FIFO 21 after the frame has been overwritten. Here, eight exemplary overwrite patterns are assumed and described.

The overwrite patterns are:

(1) Pattern 1: A normal frame (n) is overwritten with a normal frame (n);

(2) Pattern 2: A normal frame (n) is overwritten with a sequence end frame (e);

(3) Pattern 3: A normal frame (n) is overwritten with a sequence end frame (e) and the frame is further overwritten with a stream change frame (c);

(4) Pattern 4: A normal frame (n) is overwritten with a sequence end frame (e) and the frame is overwritten with a stream change frame (c), and the frame is further overwritten with a normal frame (n);

(5) Pattern 5: A sequence end frame (e) is overwritten with a stream change frame (c);

(6) Pattern 6: A sequence end frame (e) is over written with a stream change frame (c) and the frame is further overwritten with a normal frame (n);

(7) Pattern 7: A stream change frame (c) is overwritten with a normal frame (n); and

(8) Pattern 8: A normal frame (n) is overwritten with a stream end frame (t).

FIG. 23 is a diagram illustrating a pattern 1. Since the last FIFO block of the FIFO 21 contains data of frame 2 in FIG. 23, an overwrite with frame 3 occurs and the overwrite counter OWC in the supplementary header section 33 is incremented to “1”. The image data Im and header information Hd of frame 3, which is a normal frame, are stored in the last FIFO block without any manipulations.

In the supplementary header section 33, the PTS (pts_2) and frame rate (f/r_2) of frame 2 that have been held in the stream change PTS and stream change frame rate before the overwrite occurred remain held in the stream change PTS and the stream change frame rate because frame 3 does not have a stream change flag (c). Since a frame with a stream end flag (t) has not yet been pushed into the FIFO block, the PTS (pts_3) and frame rate (f/r_3) of frame 3 are copied to the stream end PTS and the stream end frame rate, respectively. Since a frame with a sequence end flag (e) has not been pushed into the FIFO block, the PTS and frame rate of frame rate 3 are copied to the sequence end PTS and the sequence end frame rate, respectively.

FIG. 24 is a diagram illustrating pattern 2. In FIG. 24, since the last FIFO block of the FIFO 21 contains data of frame 3, the overwrite count OWC in the supplementary header section 33 is incremented to “1” and the sequence end count C4 is incremented to “1” when the sequence end frame (e) is overwritten. The image data Im (d) and header information Hd (including a sequence end flag e) of a dummy frame (d) are stored in the last FIFO block.

In the supplementary header section 33, the PTS (pts_3) and frame rate (f/r_3) of frame 3 that have been held in the stream change PTS and stream change frame rate before the overwrite remain held there because the dummy frame does not have a stream change flag (c).

Since a frame with a stream end flag (t) has not yet been pushed into the FIFO block, invalid data (n/a) of the dummy frame are copied to the stream end PTS and the stream end frame rate. Since the frame with a sequence end flag (e) has been pushed into the FIFO block, the PTS and frame rate of frame 3 remain held in the sequence end PTS and the sequence end frame rate, respectively.

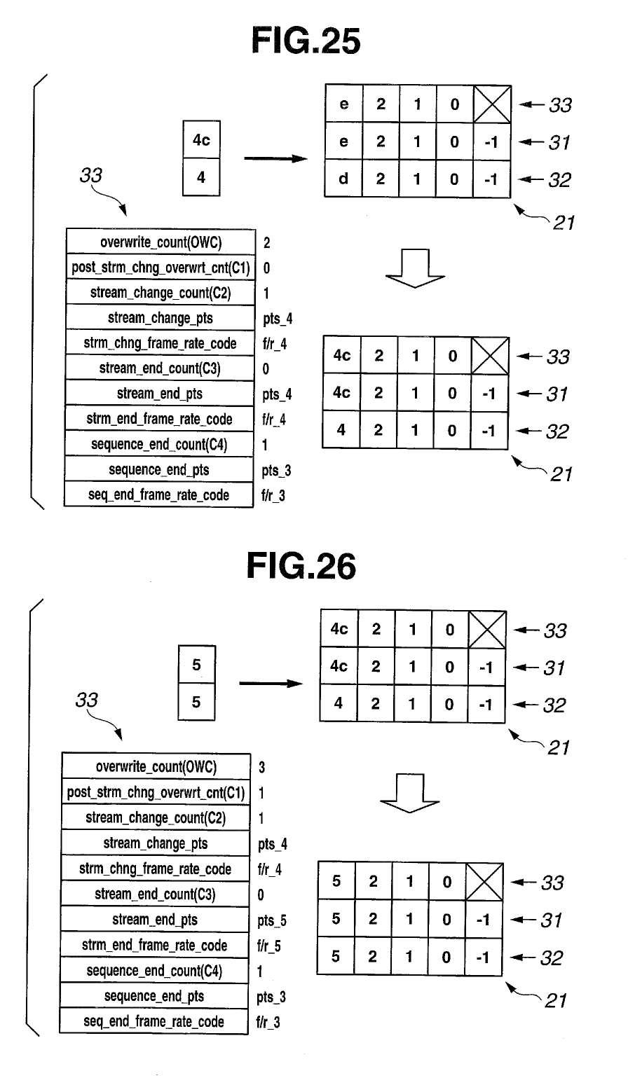

FIG. 25 is a diagram illustrating pattern 3. In FIG. 25, since the last FIFO block of the FIFO 21 contains data of the sequence end frame (e) as a result of the overwrite illustrated in FIG. 24, the overwrite count OWC in the supplementary header section 33 is incremented to “2” when the data is overwritten with normal frame 4, which is a stream change frame (c). Since the stream change (STC) has occurred, the stream change count C2 is incremented to “1”. The image data Im and header information Hd (including a stream change flag c) of the stream change frame 4 (c) are stored in the last FIFO block.

In the supplementary header section 33, the PTS (pts_4) and frame rate (f/r_4) of frame 4 are copied to the stream change PTS and the stream change frame rate, respectively, because the frame having a stream change flag (c) has been pushed.

Since a frame with a stream end flag (t) has not yet been pushed into the FIFO block, the PTS and frame rate of frame 4 are copied to the stream end PTS and the stream end frame rate. Since the frame with a sequence end flag (e) has already been pushed into the FIFO block, the PTS (pts_3) and frame rate (f/r_3) of frame rate 3 preceding the sequence end frame remain held in the sequence end PTS and the sequence end frame rate, respectively.

FIG. 26 is a diagram illustrating pattern 4. In FIG. 26, since the last FIFO block of the FIFO 21 contains the data of normal frame 4, which is a stream change (STC) frame as a result of overwrite shown in FIG. 25, the overwrite count OWC in the supplementary header section 33 is incremented to “3” when the data is overwritten with normal frame 5. Since a frame with a stream change flag (c) has already been pushed into the FIFO block, the post stream change overwrite count C1 is incremented to “1”. The image data Im and header information Hd of frame 5 are stored in the last FIFO block.

Since the frame with a stream change flag (c) has been pushed into the FIFO block, the stream change PTS and the stream change frame rate in the supplementary header section 33 are not updated and the PTS and frame rate of frame 4 remain held.

Since a frame with a stream end flag (t) has not yet been pushed into the FIFO block, the PTS and frame rate of frame 5 are copied to the stream end PTS and the stream end frame rate, respectively. Since the frame with a sequence end flag (e) has already been pushed into the FIFO block, the PTS and frame rate of frame 3 remain held in the sequence end PTS and sequence end frame rate, respectively.

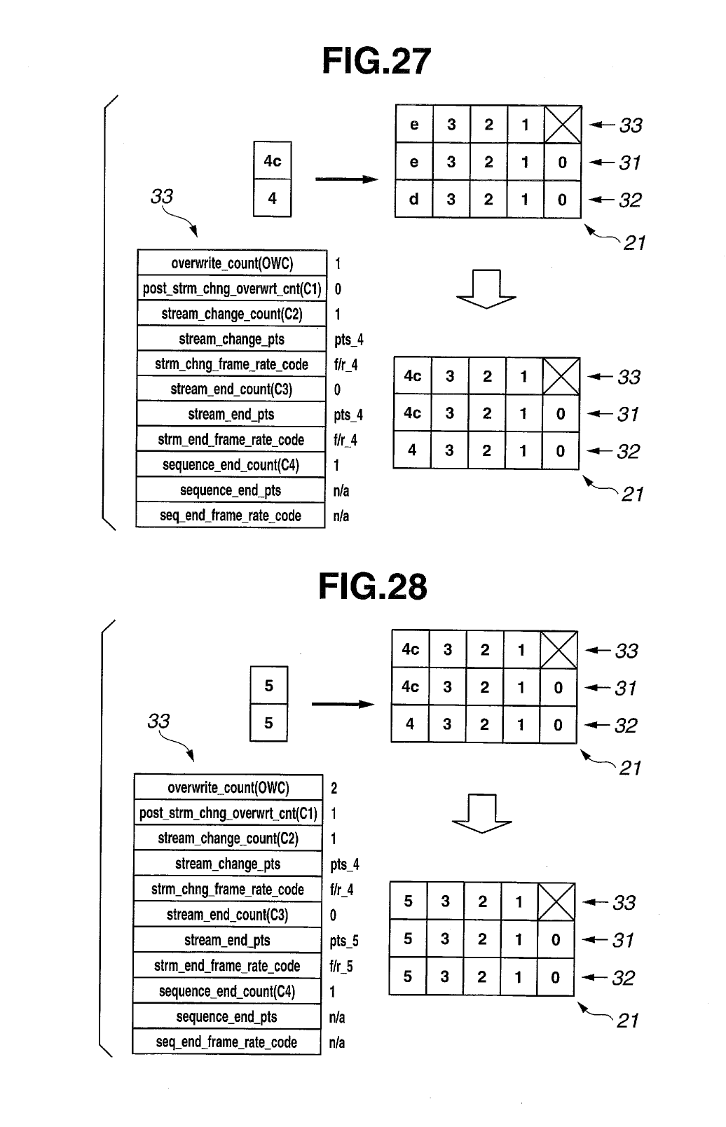

FIG. 27 is a diagram illustrating pattern 5. In FIG. 27, since the last FIFO block of the FIFO 21 contains data d of a dummy frame (d) of a sequence end frame (e), the overwrite count OWC in the supplementary header section 33 is incremented to “1” when the data is overwritten with frame 4, which is stream change (STC) frame. Since the stream change (STC) has occurred, the stream change count C2 is incremented to “1”. The image data Im and header information Hd of frame 4 are stored in the last block.

Since the frame with a stream change flag (c) has been pushed, the stream change PTS and the stream change frame rate in the supplementary header section 33 are updated with the PTS (pts_4) and frame rate (f/r_4) of frame 4.

Since a frame with a stream end flag (t) has not yet been pushed into the FIFO block, the PTS and frame rate of frame 4 are copied to the stream end PTS and the stream end frame rate. Since the frame with a sequence end flag (e) has already been pushed into the FIFO block, the invalid data (n/a) of the sequence end frame that have been held before the overwrite remain held in the sequence end PTS and the sequence end frame rate.

FIG. 28 is a diagram illustrating pattern 6. In FIG. 28, since the last FIFO block of the FIFO 21 contains the data of frame 4, which is a stream change (STC) frame that has been written by the overwrite as illustrated in FIG. 27, the overwrite count OWC in the supplementary header section 33 is incremented to “2” when the data is overwritten with normal frame 5. Since the frame with a stream change flag (c) has already been pushed into the FIFO block, the post stream change overwrite count C1 is increment to “1”. The image data Im and header information Hd (5) of frame 5 are stored in the last FIFO block.

Since the frame with a stream change flag (c) has already been pushed into the FIFO block, the stream change PTS and the stream change frame rate in the supplementary header section 33 are not updated and the PTS (pts_4) and frame rate (f/r_4) of frame 4 remain held.

Since a frame with a stream end flag (t) has not yet been pushed into the FIFO block, the PTS (pts_5) and frame rate (f/r_5) of frame 5 are copied to the stream end PTS and the stream end frame rate, respectively. Since the frame with a sequence end flag (e) has already been pushed into the FIFO block, the invalid data (n/a) of the sequence end frame held before the overwrite in FIG. 27 remains held in the sequence end PTS and sequence end frame rate.

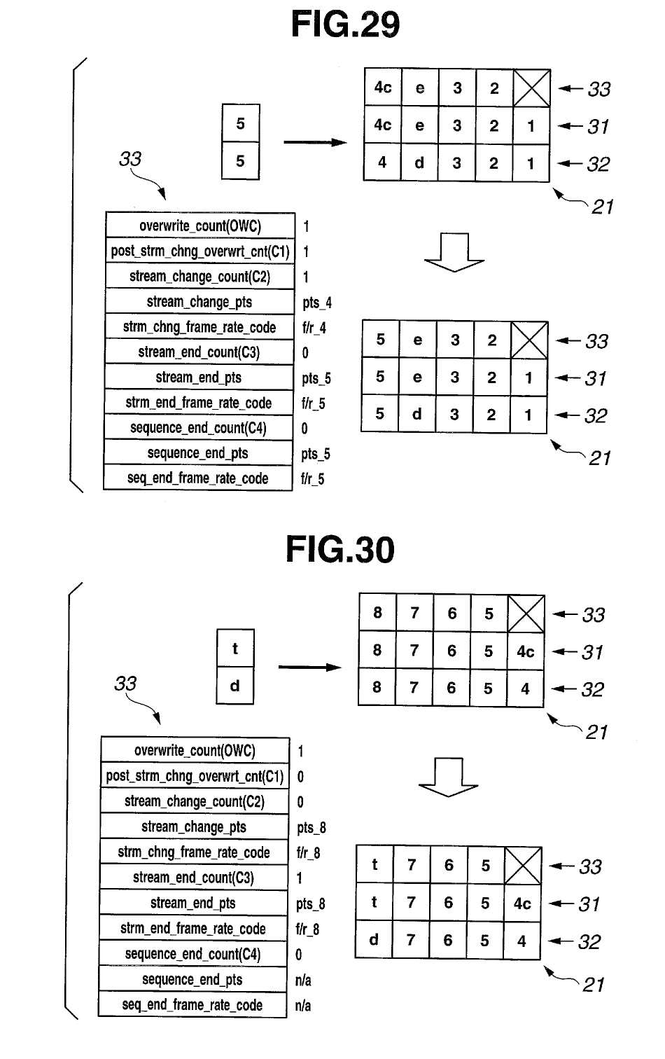

FIG. 29 is a diagram illustrating pattern 7. In FIG. 29, since the last FIFO block of the FIFO 21 contains the data of normal frame 4 with the stream change (STC), the overwrite count OWC in the supplementary header section 33 is incremented to “1” when the data is overwritten with normal frame 5. Since the frame with the stream change flag (c) has already been pushed into the FIFO block, the post stream change overwrite count C1 is incremented to “1”. The image data Im and header information Hd of frame 5 are stored in the last FIFO block.

Since the frame with a stream change flag (c) has already been pushed into the FIFO block, the stream change PTS and the stream change frame rate in the supplementary header section 33 are not updated and the PTS (pts_4) and frame rate (f/r_4) of frame 4 remain held.

Since a frame with a stream end flag (t) has not yet been pushed into the FIFO block, the PTS (pts_5) and frame rate (f/r_5) of frame 5 are copied to the stream end PTS and the stream end frame rate, respectively. Since the frame with a sequence end flag (e) has not yet been pushed into the FIFO block, the PTS and frame rate of frame 5 are copied to the sequence end PTS and sequence end frame rate, respectively.

FIG. 30 is a diagram illustrating pattern 8. In FIG. 30, since the last FIFO block of the FIFO 21 contains data of frame 8, which is a normal frame, the overwrite count OWC in the supplementary header section 33 is incremented to “1” when the data is overwritten with a dummy frame of a stream end (STE). The stream end count C3 is also incremented to “1” because the stream end (STE) has been encountered. The image data Im (d) and header information Hd (including a stream end flag t) of the dummy frame are stored in the last FIFO block.

The stream change PTS and the stream change frame rate in the supplementary header section 33 are not updated and the PTS (pts_8) and frame rate (f/r_8) of frame 8 remain held because frame 8 does not have a stream change flag (c).

Since the frame with a stream end flag (t) has been pushed into the FIFO block, the PTS and frame rate of frame 8 remain held in the stream end PTS and the stream end frame rate. Since a frame with a sequence end flag (e) has not yet been pushed into the FIFO block, invalid data (n/a) of the stream end frame pushed is copied to the sequence end PTS and sequence end frame rate, respectively.

(Data Pop from the FIFO)

Popping of data from the FIFO 21 will be described below.

As described with reference to FIG. 16, header information Hd, image data pre-read header information pHd, and overwrite information OWI are outputted from the pre-read header manipulating unit 24 when data is popped.

The overwrite information will be described first.

### (Overwrite Information)

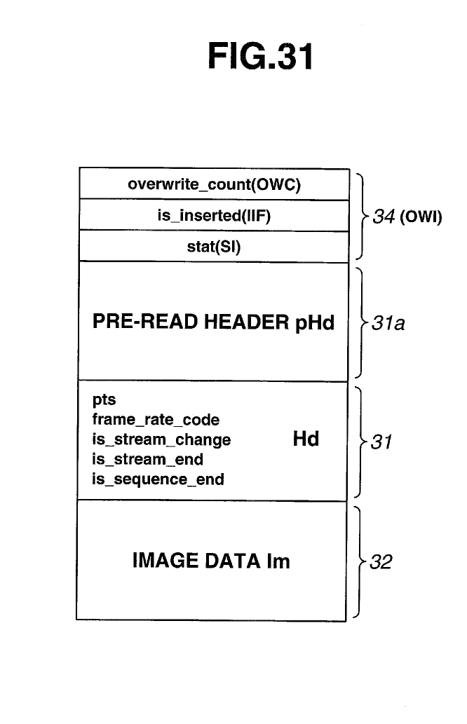

Overwrite information generated by the pre-read header manipulating unit 24 will be described. FIG. 31 is a diagram illustrating a structure of data generated and outputted by the pre-read header manipulating unit 24. The output data includes overwrite information OWI, pre-read header information pHd, header information Hd, and image data Im.

The overwrite information OWI includes an overwrite count OWC, inserted-frame information (is inserted) IIF and a status code S1.

The overwrite count (OWC) indicates the number of frames that have overwritten the frame.

The inserted-frame information IIF indicates whether the frame is an inserted frame or not. If the inserted-frame information represents “true”, it means that the image data is invalid.

The status code (stat) SI indicates status such as an error status and is used for notifying a double overwrite of a flag.

As described above, the overwrite information OWI is generated by the pre-read header manipulating unit 24 when data is popped. The data illustrated in FIG. 31 is outputted from the pre-read header manipulating unit 24.

### (Pre-Read Header Information)

Contents in the pre-read header pHd when data is popped from the FIFO 21 will be described below. As described earlier, when data is popped, the pre-read header information pHd is partially modified or manipulated by the pre-read header manipulating unit 24 and is outputted. Specifically, when the pre-read header manipulating unit 24 as a header information manipulating unit reads the image data Im and header information Hd of the oldest frame stored in the FIFO 21, the pre-read header manipulating unit 24 reads the header information Hd of the next oldest frame and manipulates the header information Hd of the next oldest frame on the basis of supplementary header information Shd generated by the supplementary header adding unit 23.

Alterations of pre-read header information in different cases will be described below.

(In a Case where No Overwrite has Occurred)

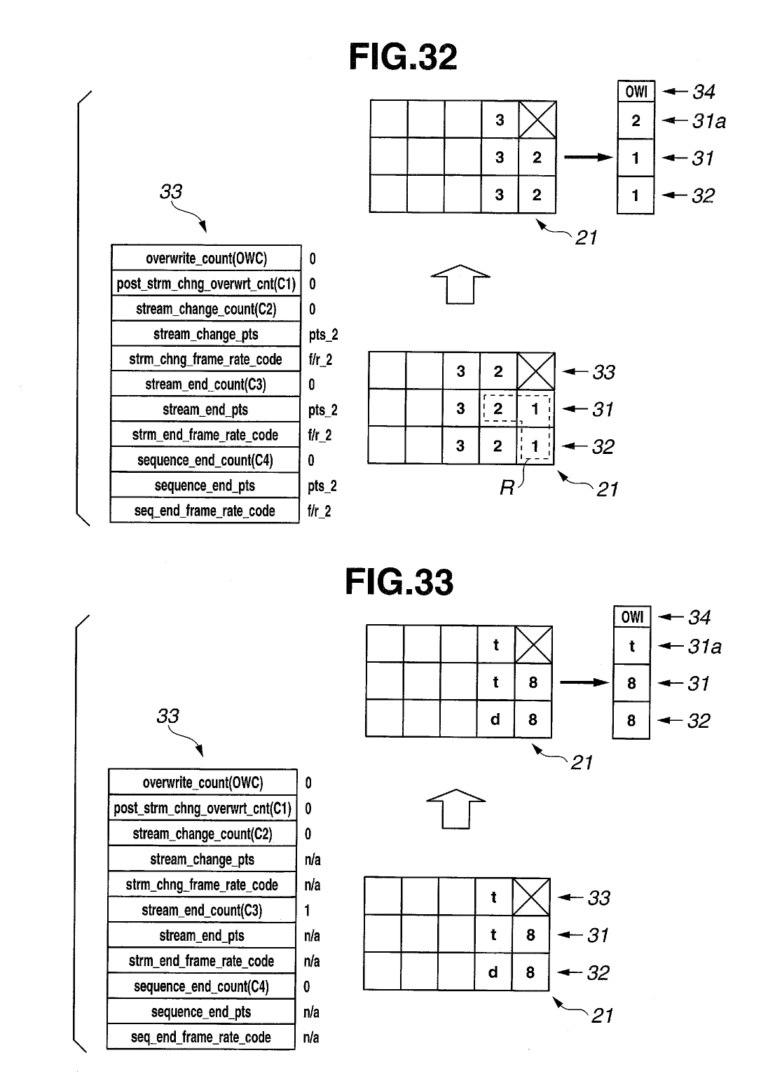

FIGS. 32 through 34 are diagrams illustrating a configuration of output data in a case where an overwrite has not occurred. The output data includes an overwrite information section 34 containing overwrite information OWI, a pre-read header section 31a containing pre-read header information pHd, a header section 31 containing header information Hd, and an image section 32 containing image data Im. The lower left part of each diagram shows supplementary header information Shd of a second block from the top of the FIFO 21 before popping of a frame. The pre-read header information pHd is manipulated on the basis of the supplementary header information Shd.

FIG. 32 is a diagram illustrating a configuration of output data in a case where an overwrite has not occurred. In the case in FIG. 32, normal frames are outputted in order without being overwritten. The fact that an overwrite has not occurred can be determined from the overwrite count (OWC) equal to 0 (zero) in the supplementary header. It can be determined that a frame is a normal frame if all discontinuity flag counts (C2, C3 and C4) are 0 (zero). In this example, the overwrite count OWC in the overwrite information in the overwrite information section 34 is 0 because the overwrite count OWC in the supplementary header section 33 is 0 (zero). The inserted-frame information IIF represents “false”, which indicates that the popped data is not additionally inserted data. The header information of frame 2 is directly outputted to the pre-read header information pHd in the pre-read header section 31a.

FIG. 33 is a diagram illustrating a configuration of output data in a case where an overwrite has not occurred and a stream end (STE) is outputted to the pre-read header. The fact that an overwrite has not occurred can be determined from the overwrite count (OWC) equal to 0 (zero) in the supplementary header. The fact that a stream end (STE) has encountered can be determined from the stream end count (C3) not equal to 0 (zero). In this case, in FIG. 33, when frame 8, which is a normal frame, is outputted, the overwrite count OWC in the overwrite information OWI in the overwrite information section 34 is 0 (zero) because the overwrite count OWC in the supplementary header section 33 is 0 (zero). The inserted-frame information IIF represents “false”. The header information Hd of a dummy frame (d) of the stream end (STE) is directly outputted to the pre-read header pHd in the pre-read header section 31a. However, in order to output a stream change frame as the last frame as illustrated in FIG. 15, the data in the FIFO is kept from moving one block forward. Information indicating that the stream end (STE) has been detected is held in a predetermined memory area, not shown, in the FIFO 21.

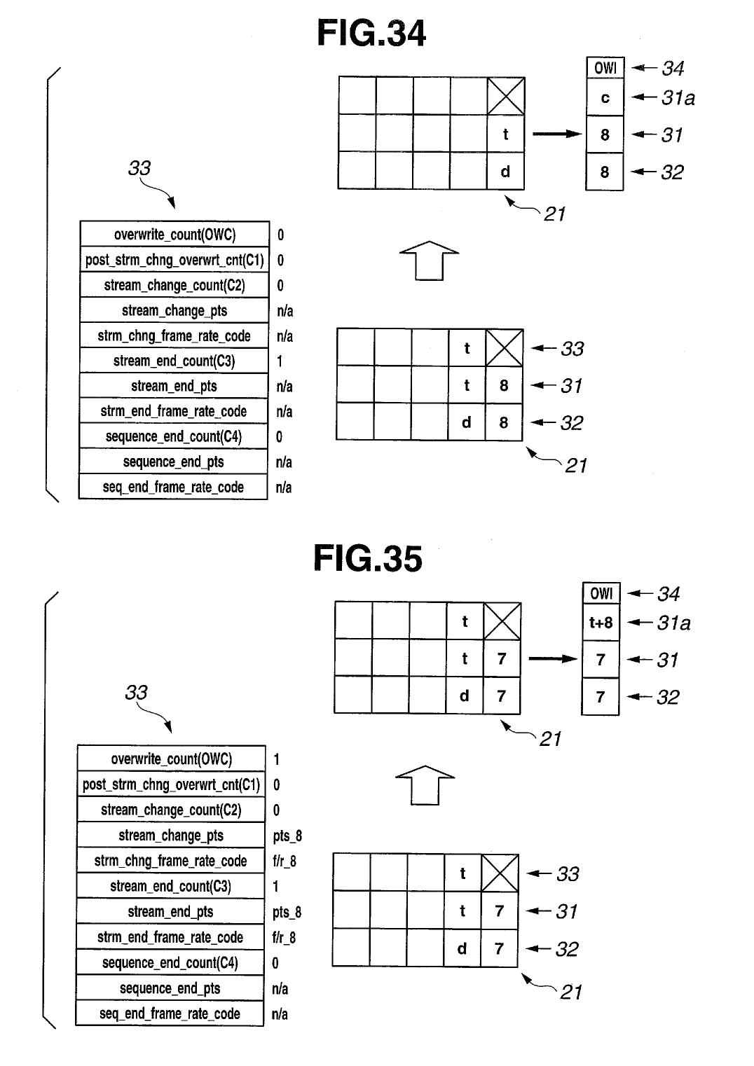

FIG. 34 is a diagram illustrating a configuration of output data in a case where a stream change (STC) flag is outputted to the pre-read header as a last frame after a stream end (STE) as illustrated in FIG. 15. The fact that a stream end has encountered can be determined from information stored in a predetermined memory area, not shown, in the FIFO 21 for indicating that a stream end (STE) has been detected. In this case, after the output data described with reference to FIG. 33 has been outputted, the header information Hd and image data Im of frame 8, a pre-read header pHd in the pre-read header section 31a in which the stream change flag c is set to “1”, and overwrite information OWI are outputted as illustrated in FIG. 34, rather than directly outputting the stream end (STE) flag to the pre-read header section 31a. Since the stream change frame is additionally inserted, the inserted-frame information IIF becomes “true”. The header information Hd and image data Im of frame 8 are popped but are treated as dummy data (d).

(In a Case where an Overwrite has Occurred)

FIG. 35 is a diagram illustrating a configuration of output data in a case where a stream end flag is outputted to the pre-read header when a normal frame has been overwritten with a stream end frame (pattern 8). Since the overwrite has occurred, the overwrite count OWC is not 0 (zero). The stream end count C3 is also not 0 (zero). This means that a normal frame has been overwritten with a stream end frame. Accordingly, stream end PTS and stream end frame rate information in the supplementary header section 33 are replaced with the PTS and the frame rate information from the pre-read header section 31a. Consequently, the PTS (pts_8) and frame rate (f/r_8) of frame 8, which has been overwritten, are retained in the pre-read header section 31a. The overwrite count OWC becomes “1” (the overwrite count OWC is copied from the supplementary header) and the inserted-frame information IIF becomes “false”. The contents in the FIFO 21 is not changed, that is, not moved forward. Since the stream end (STE) has been outputted to the pre-read header, information indicating that the stream end (STE) has been detected is held in a predetermined memory area, not shown, in the FIFO 21. The rest of the process is similar to that in FIG. 34.

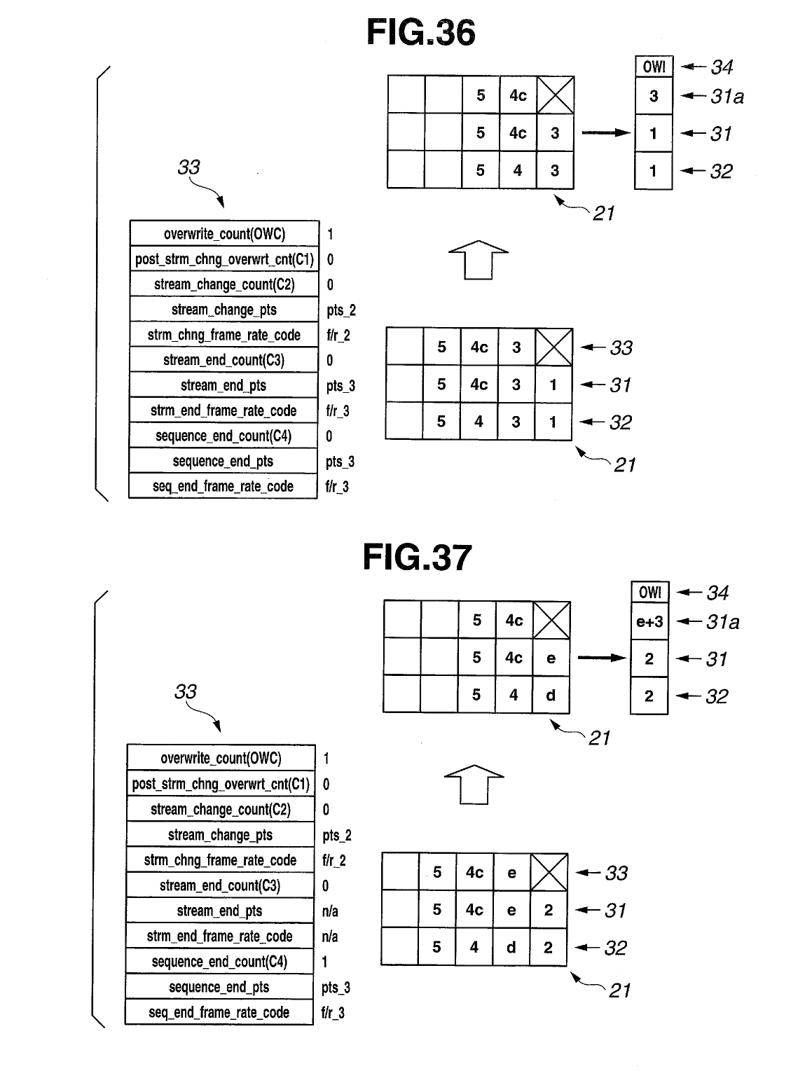

FIG. 36 is a diagram illustrating a configuration of output data in a case where a normal frame is outputted when a normal frame has been overwritten with another normal frame (pattern 1). Since the overwrite has occurred, the overwrite count OWC is not 0 (zero), and all of the discontinuity flag counts (C1, C2 and C3) are 0 (zero). This means that a normal frame has been overwritten with another normal frame. Accordingly, the pre-read header section 31a is outputted without being manipulated. The overwrite count OWC becomes “1” (the overwrite count OWC is copied from the supplementary header) and the inserted-frame information IIF becomes “false”.

FIG. 37 is a diagram illustrating a configuration of output data in a case where a sequence end flag is outputted to the pre-read header when a normal frame has been overwritten with a sequence end frame (pattern 2). Since the overwrite has occurred, the overwrite count OWC is not 0 (zero), and the stream change count C2 and the stream end count C3 are 0 (zero), and the sequence end count C4 is not 0 (zero). This means that a normal frame has been overwritten with a sequence end frame. Accordingly, the sequence end PTS and the sequence end frame rate information in the supplementary header section 33 are replaced with the PTS and the frame rate information in the pre-read header section 31a. Consequently, the PTS (pts_3) and frame rate (f/r_3) information of frame 3, which has been overwritten, are retained in the pre-read header section 31a. The overwrite count OWC becomes “1” (the overwrite count OWC is copied from the supplementary header information) and the inserted-frame information IIF becomes “false”.

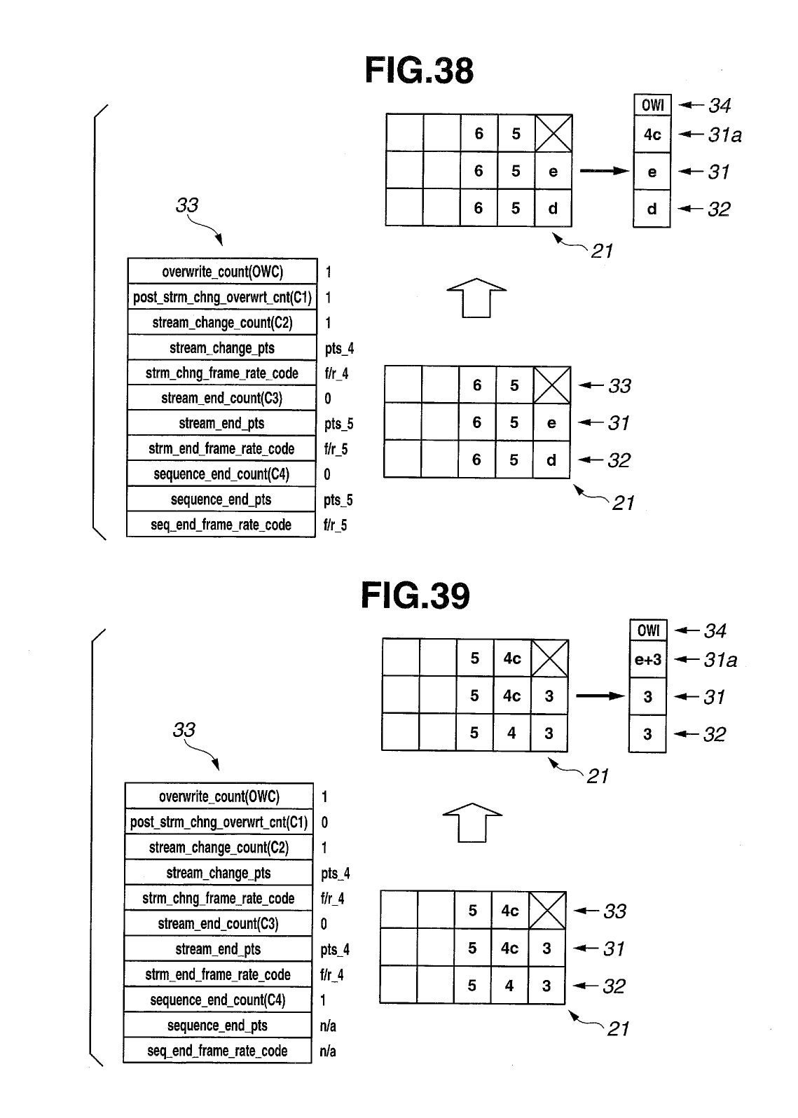

FIG. 38 is a diagram illustrating a configuration of output data in a case where a stream change flag is outputted to the pre-read header when a stream change frame has been overwritten with a normal frame (pattern 7). Since the overwrite has occurred, the overwrite count OWC is not 0 (zero). The stream end count C3 and the sequence end count C4 are 0 (zero), and the stream change count C2 is not 0 (zero). This means that a stream change frame has been overwritten with a normal frame. Accordingly, the stream change PTS and the stream change frame rate information in the supplementary header section 33 are replaced with the PTS and the frame rate information in the pre-read header section 31a, and the stream change flag c is set to “1”. Consequently, the PTS and frame rate information of frame 4, although the stream change frame has been overwritten, are retained in the pre-read header section 31a and the frame with the stream change flag is popped. Since the overwritten stream change frame has been added, the inserted-frame information IIF becomes “true”. In this case, the contents in the FIFO 21 is not changed, that is, not moved forward. Since the inserted-frame information IIF is “true”, the image data Im of the data outputted will be ignored. Because the frame has been inserted, the frame can be treated as not having overwritten another frame. Accordingly, the overwrite count OWC in the pre-read header section 31a becomes “0”. Since the stream change (STC) has been outputted to the pre-read header, information indicating that the stream change (STC) has been detected is held in a predetermined memory area, not shown, in the FIFO 21.

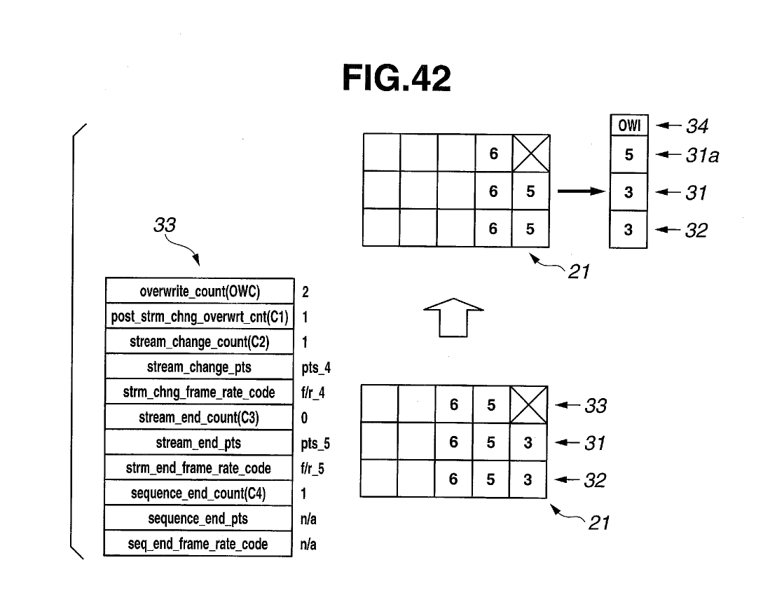

While a dummy frame is outputted next to the data illustrated in FIG. 38, the pre-read header section 31a contains the header information Hd of frame 5 (the same processing as that illustrated in FIG. 42).

FIG. 39 is a diagram illustrating a configuration of output data in a case where a sequence end flag is outputted to the pre-read header when a sequence end frame has been overwritten with a stream change frame (pattern 5). Since the overwrite has occurred, the overwrite count OWC is not 0 (zero). The stream end count C3 is 0 (zero) and the sequence end count C4 and the stream change count C2 are not 0 (zero). This means that a sequence end frame has been overwritten with a stream change frame. Accordingly, the sequence end PTS and the sequence end frame rate information in the supplementary header section 33 are replaced with the PTS and the frame rate information in the pre-read header section 31a, and the stream change flag e is set to “1”. Consequently, the PTS and frame rate information of frame 3 are retained in the pre-read header section 31a and a frame with a sequence end flag is popped, although the sequence end frame has been overwritten. Since the overwritten sequence end frame has been added, the inserted-frame information IIF becomes “true”. In this case, the contents in FIFO 21 is not changed, that is, not moved forward. The post stream change overwrite count C1 and the count of one stream change frame are subtracted from the total overwrite count OWC to set the overwrite count before the sequence end “OWC-C1-1” as the overwrite count OWC in the pre-read header section 31a. Since the sequence end (SQE) has been outputted to the pre-read header, information indicating that the sequence end (SQE) has been detected is held in a predetermined memory area, not shown, in the FIFO 21.

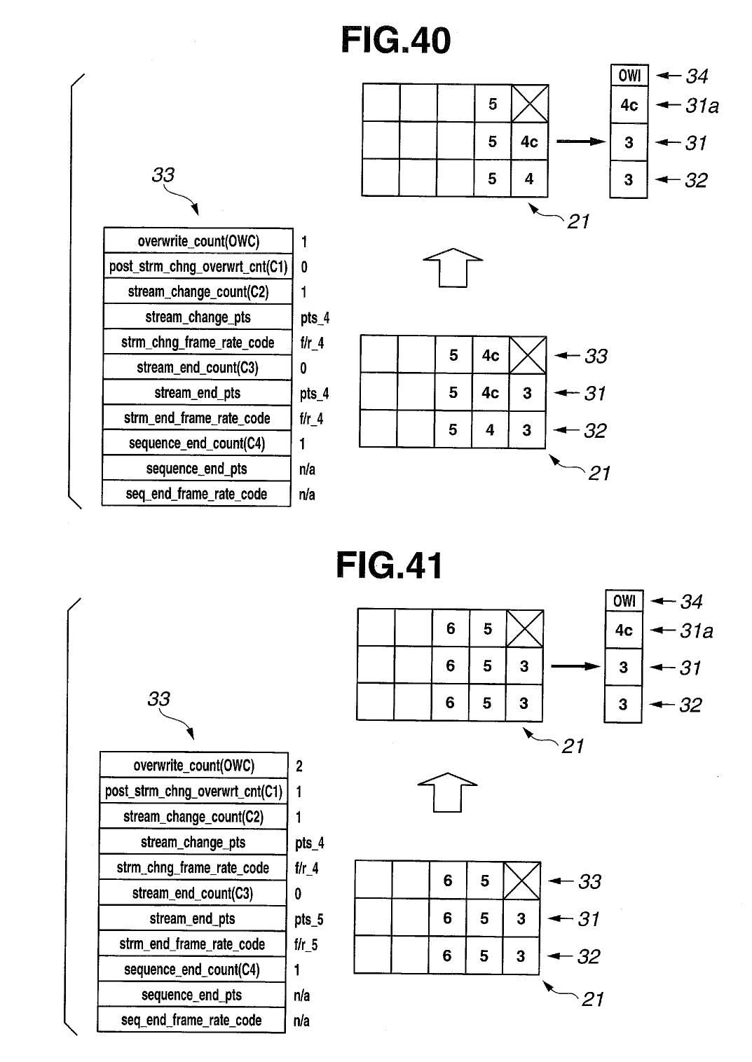

FIG. 40 is a diagram illustrating a configuration of output data in a case where a stream change flag is outputted to the pre-read header when the stream change frame in FIG. 39 has not been overwritten. Since the information indicating that a sequence end (SQE) has been detected is held in the predetermined memory area, not shown, in the FIFO 21, it is determined that the process illustrated in FIG. 39 has just been done. In addition, the post stream change overwrite count C1 is 0 (zero), which means that the stream change frame has not been overwritten. Accordingly, in the case in FIG. 40, the header information of frame 4 is directly outputted to the pre-read header information pHd in the pre-read header section 31a. Since the stream change frame has overwritten the immediately preceding sequence end frame, the overwrite count OWC is “1”. Since the stream change flag which has not been overwritten is directly outputted, the inserted-frame information is “false”.

FIG. 41 is a diagram illustrating a configuration of output data in a case where a stream change flag is outputted to the pre-read header when the stream change frame in FIG. 39 has been further overwritten with a normal frame (pattern 6). Since the information indicating that a sequence end (SQE) has been detected is held in the predetermined memory area, not shown, in the FIFO 21, it is determined that the process illustrated in FIG. 39 has just been done. The post stream change (STC) overwrite count C1 is not 0 (zero), which means that the stream change frame has been overwritten with a normal frame. Accordingly, the stream change PTS and the stream change frame rate information in the supplementary header section 33 are replaced with the PTS and the frame rate information in the pre-read header section 31a, and the stream change flag c is set to “1”. Consequently, the PTS and frame rate information of frame 4 are retained in the pre-read header section 31a and a frame with the stream change flag is popped, although the stream change frame has been overwritten. Since the overwritten stream change frame has been added, the inserted-frame information IIF becomes “true”. Since the stream change frame has overwritten the immediately preceding sequence end frame, the overwrite count OWC is “1”. In this case, the contents in the FIFO 21 is not changed, that is, not moved forward. Since the stream change (STC) has been outputted to the pre-read header, information indicating that the stream change (STC) has been detected is held in a predetermined memory area, not shown, in the FIFO 21.

FIG. 42 is a diagram illustrating a configuration of output data when data is popped after the process illustrated in FIG. 41. Since the information indicating that the stream change (STC) has been detected is held in the predetermined memory area, not shown, in the FIFO 21, it is determined that the process in FIG. 41 has been done. In the case in FIG. 42, the header section 31 and the image section 32 of frame 3, and the pre-read header section 31a (the header information Hd of frame 5) are outputted. Since a sequence end frame and a stream change frame are popped even if overwritten (FIGS. 39 and 41) and the overwrite count before the stream change frame is reflected in the pre-read headers of the two frames, the post stream change overwrite count C1 is copied to the overwrite count OWC in the pre-read header in FIG. 42.

### (Time Intervals Between Multiple Frames Contained in a Stream and Frame Extraction Intervals)

As has been described, data outputted from the pre-read header manipulating unit 24 includes PTSs and frame rates as data used for calculating times td1, td11, td12 and td13 illustrated in FIGS. 10 and 11.

On the other hand, a moving image contained in a stream is displayed by changing multiple frame images one after another at predetermined intervals.

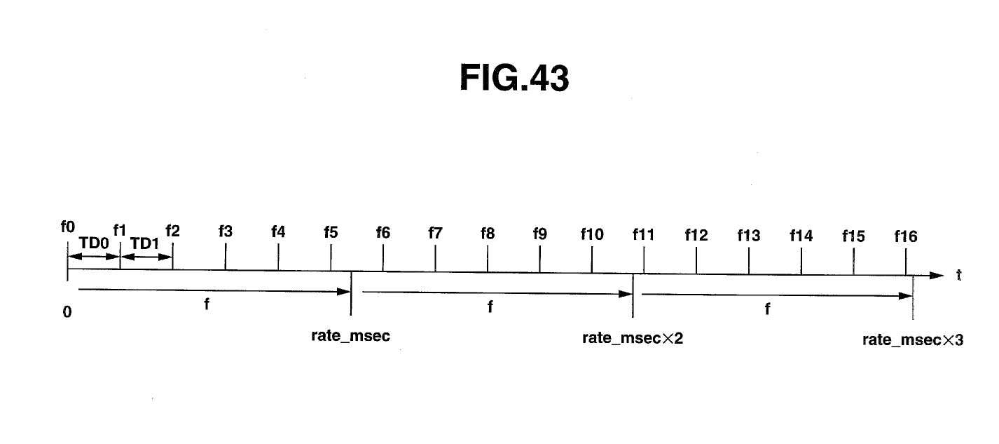

FIG. 43 is a diagram illustrating the relationship between frames displayed and time intervals at which frames to which image processing is to be applied are specified (hereinafter the time interval is referred to as specification time) f (rate_msec). Based on the specification time f which is an interval in which image processing is to be applied, the image processing is performed on a frame outputted in every specified time f, starting from the start of (or from some midpoint in) the stream.

As illustrated in FIG. 43, each of the continuous frames is continuously displayed until the display start time of a next frame. For example, frame f0 is continuously displayed during time period TD0 until the display start time of frame f1, then the frame f1 is displayed. Frame f1 is continuously displayed during time period TD1 until the display start time of frame f2, and so on.

The specification time f is determined on the basis of the elapsed time from the time (0) of the start of the stream. In FIG. 43, after the specification time f has elapsed since the time of the start (0), frame 5 is outputted. Accordingly, frame 5 is determined to be a frame to which image processing is to be applied, that is, a frame to be extracted. A next frame is extracted after the next specification time f has elapsed. In FIG. 43, frame 10 is outputted. Accordingly, frame 10 is determined to be a frame to which the image processing is to be applied, that is, a frame to be extracted. After the next specification time f has elapsed, frame 16 is outputted. Accordingly, frame 16 is determined to be a frame to which the image processing is to be applied, that is, a frame to be extracted.

As described earlier, data outputted from the pre-read header manipulating unit 24 includes a manipulated pre-read header section 31a, which contains the PTS of the frame even if the frame has been overwritten, and contains the PTS and frame rate as data used for calculating the time td1, td11, td12, td13 even if the frame is a discontinuous frame.

In order to make determination that is not affected by timing and a missing frame, the frame-to-be-extracted determining unit 25 makes the determination based on the PTS in principle. The frame-to-be-extracted determining unit 25 calculates the time at which each frame is to be displayed as the elapsed playback time in milliseconds (mesc) from the start of the stream. Hereinafter the playback time is referred to as elapsed time. While the time is measured in units of milliseconds, the time may be measured in other units.

As illustrated in FIG. 43, letting t(i) denote the elapsed time [msec] at frame i and f denote the specification time [msec] which is the interval in which image processing is applied, the time in which frame i is displayed is [t(i), t(i+1)]. If an integer m that results in t(i)≦f×m<t(i+1) exists, the frame is determined to be a frame to which the image processing is to be applied. More specifically, letting m′ denote the maximum m that results in f×m<t(i+1), then m′=(t(i+1)−1) div f (where div denotes integer division). Therefore, if the relation t(i)≦f×m′ holds, then the frame is determined to be a frame to which the image processing is to be applied.

The calculation requires obtaining the time instant t(i+1) of a next frame in advance. Data from the FIFO 21 includes data for pre-reading the time instant as described above.

To calculate the elapsed time from the PTS, the following factors are taken into account:

(1) The PTS at the start of a moving image stream is usually not 0 (zero).

(2) When the PTS exceeds (2³³−1), the PTS returns to 0 (zero).

(3) A value of the PTS can jump due to a discontinuity in the stream.

(4) A frame can be lost due to an overwrite that has occurred in the FIFO.

(5) The processing needs to be able to be resumed at any point in the stream.

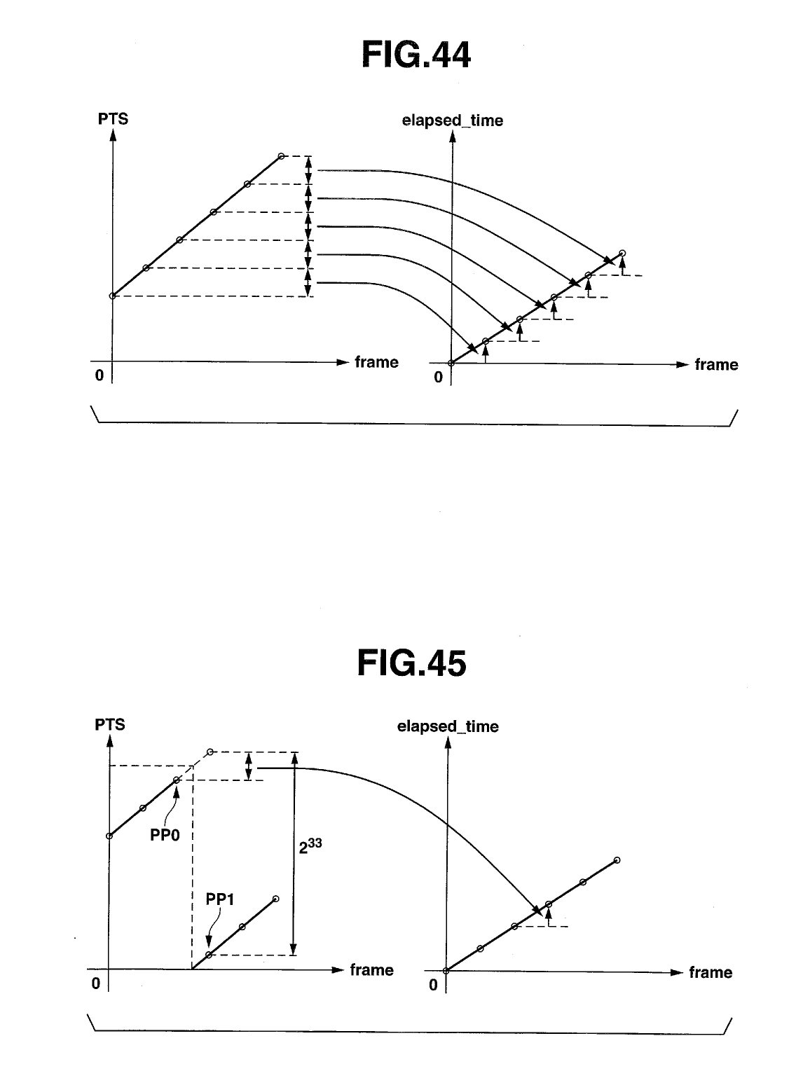

The factors given above are addressed as described below. Referring to FIGS. 44 through 49, how to calculate the elapsed time will be described. FIGS. 44 through 49 are diagrams illustrating how to calculate the elapsed time from PTS.

(a) In principle, the elapsed time is calculated by accumulating the difference in PTS between each frame and the previous frame, as illustrated in FIG. 44. In order for PTS return-to-0, stream discontinuity, suspension and resume to be accommodated as described below, the elapsed time is not calculated as the difference between the current PTS and the PTS at the start of the stream.

(b) As illustrated in FIG. 45, when the PTS has returned to 0 (zero), 2³³ is added to the PTS of frame PP1 at which the PTS has returned to 0 (zero), and then the difference from the PTS of the previous frame PP0 is calculated, thereby adjusting the return to 0 (zero).

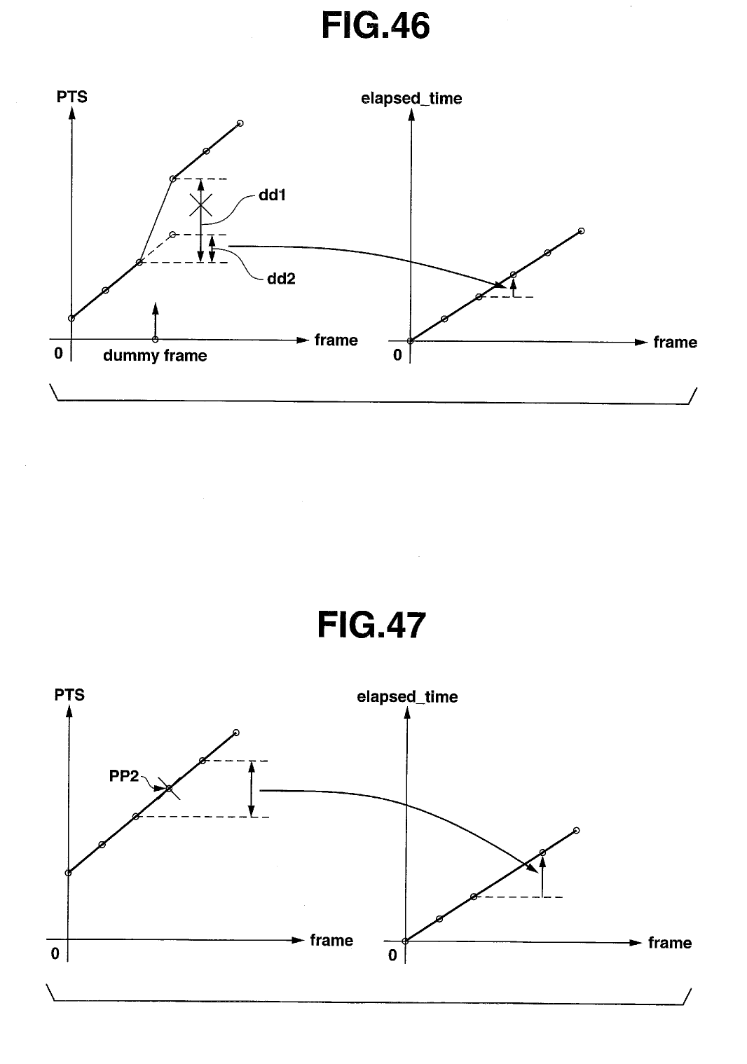

(c) When a discontinuity has occurred in the stream, a dummy frame is inserted as illustrated in FIG. 46 and the discontinuity is indicated by a discontinuity flag. In that case, the elapsed time is calculated from an increase dd2 in PTS estimated from the frame rate, rather than accumulating a difference dd1 in PTS.

(d) Since the elapsed time is calculated from a difference in PTS, loss of an intermediate normal frame PP2 caused by a stream data error or an overwrite does not pose a problem, as illustrated in FIG. 47.

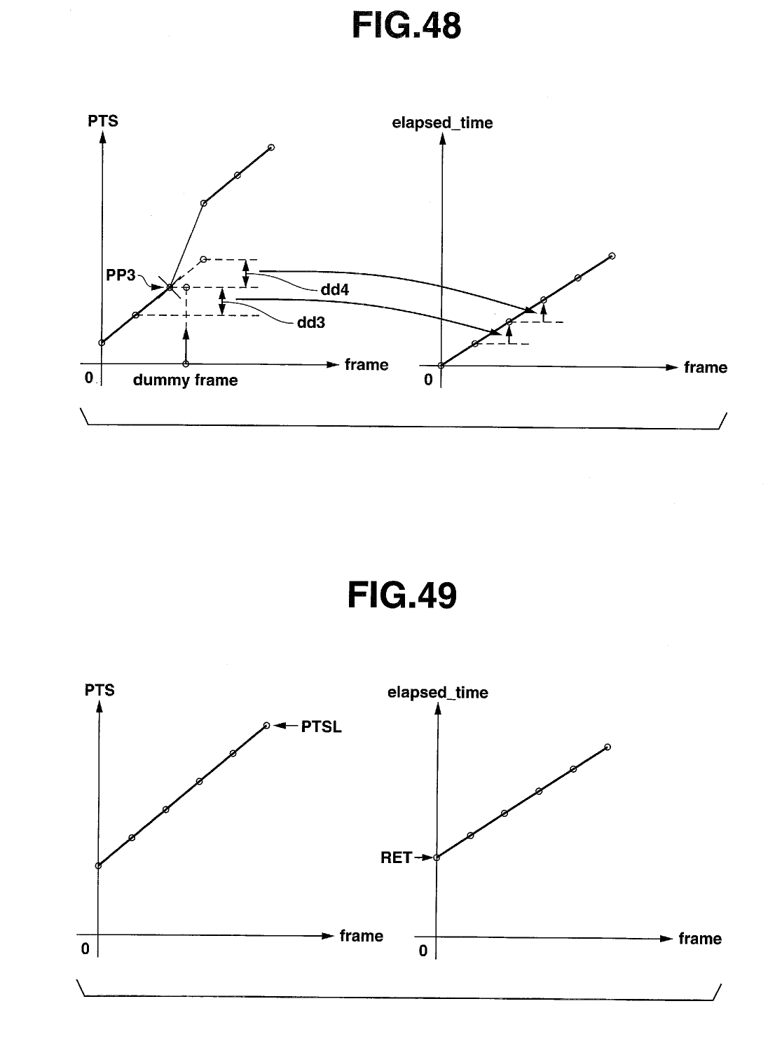

(e) However, as illustrated in FIG. 48, when a dummy frame with a discontinuity flag has overwritten the preceding valid frame PP3, the PTS of the preceding valid frame that is copied to the dummy frame and inputted is used to calculate a PTS increase dd3 to the PTS of frame PP3, and a PTS increase dd4 estimated from the frame rate of the preceding valid frame that is copied to the dummy frame and inputted is used to calculate the elapsed time. When frames with discontinuity flags themselves have been overwritten, the frames are recovered by the function of the FIFO described above and therefore processing similar to that illustrated in FIG. 48 can be performed.

(f) As illustrated in FIG. 49, the PTS and elapsed time of the last valid frame that has been processed before a suspension are recorded and are specified as indications (PTSL and RET in FIG. 49) of a resume point. After resuming, the difference in PTS between each frame and the preceding frame is accumulated to the elapsed time accumulating register 25a, where the initial value is set to RET, thereby the elapsed time at the resume point is made equal to the value before the suspension. Consequently, the elapsed time after the resume point becomes equal to the elapsed time that would be obtained if the suspension had not occurred.

### (Frame-To-Be-Extracted Determining Unit)

The frame-to-be-extracted determining unit 25 as a frame-to-be processed determining unit receives image data Im, header information Hd, pre-read header information pHd, and overwrite information OWI and determines a frame to be extracted on the basis of the data it received.

As described with respect to FIG. 43, a corresponding frame is determined at every set specification time f as a frame to be extracted. Specifically, the frame-to-be-extracted determining unit 25 uses the PTS data included in each frame data of the stream to accumulate the elapsed time from the start of the stream in an elapsed time accumulating register 25a and determines, from the accumulated elapsed time ET at each frame, whether a frame corresponds to a time interval of the specification time f. If the frame is identified as the corresponding frame, the frame is extracted as a frame to which the image processing is to be applied.

### (Processing in the Frame-To-Be-Extracted Determining Unit 25)

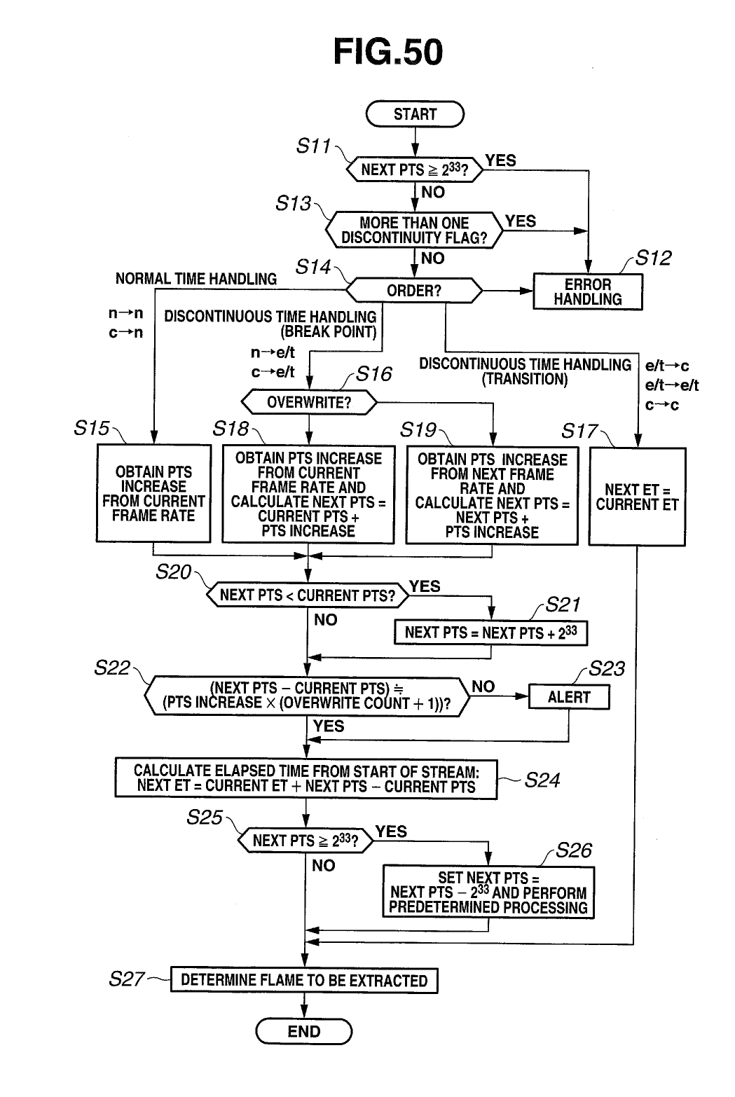

Processing in the frame-to-be-extracted determining unit 25 will be described below. FIG. 50 is a flowchart illustrating an exemplary processing flow in the frame-to-be-extracted determining unit 25. The processing in FIG. 50 is performed every time data is outputted from the pre-read header manipulating unit 24.

First, the frame-to-be-extracted determining unit 25 determines whether the PTS in the pre-read header information pHd in data read from the pre-read header manipulating unit 24 (next_pts; hereinafter referred to as the next PTS) is greater than or equal to 2³³ (step S11). If the next PTS is greater than or equal to 2³³, the value is incorrect or abnormal, the determination at step S11 is YES and the process proceeds to error handling (step S12).

Then, the frame-to-be-extracted determining unit 25 determines whether there is more than one discontinuity flag in the pre-read header information pHd (step S13). If the determination at step S13 is YES, that is, there is more than one discontinuity flag, it is abnormal and therefore the process proceeds to error handling (step S12). This is because it is impossible that there are two or more of the sequence end flag e, the stream end flag t, and the stream change flag c in the pre-read header information pHd, that is, two or more of the flags are “true”.

If the determination at step S13 is NO, the frame-to-be-extracted determining unit 25 checks the order in which a discontinuity flag and a normal flag appear (step S14). Possible orders include, in addition to the orders in the eight overwrite patterns described above, an order in which no overwrite occurs. There are four possible results of the determination at step S14. Depending on the order in which discontinuity flags in the header information Hd and discontinuity flags in the pre-read header information pHd appear, the process branches to one of four paths: normal time handling, discontinuous time handling of a discontinuity point at a break point, discontinuous time handling of discontinuity points during transition, and error handling.

If a normal frame (n) follows a valid frame (that is, a normal frame (n) or a frame with a stream change flag representing “true” (stream change frame (c)), the normal time handling is to be performed and the process proceeds to step S15.

If a dummy frame indicating a discontinuity point (a frame with a sequence end flag e or a stream end flag t that represents “true”) follows a valid frame (that is, a normal frame (n) or a stream change frame (c)), the discontinuous time handling of a discontinuity point at a break point is to be processed and the process proceeds to step S16.

If a frame with a stream change flag c representing “true” follows a dummy frame, two dummy frames successively appear, or two frames with a stream change flag c representing “true” successively appear, the discontinuous time handling of discontinuity points during transition is to be performed and the process proceeds to step S17.

In the case of an order other than those described above, the order of discontinuity flags is incorrect and therefore the process proceeds to the error handling (step S12).

In the case of normal time handing, the next PTS is the PTS in the pre-read header information pHd and therefore the next PTS does not need to be calculated. Accordingly, a PTS increase (pts_step_from_framerate) ptsd1 is obtained from the frame rate cfr in the header information Hd (curr_frame_rate; hereinafter referred to as the current frame rate) at step S15. That is, the PTS increase ptsd1 when one frame has moved forward is obtained from the current frame rate cfr in the header information Hd.

In the discontinuous time handling of a discontinuity point at a break point, which is performed when a dummy frame indicating a discontinuity point follows a valid frame, the difference between the PTS in the header information Hd (curr_pts; hereinafter referred to as the current PTS) and the next PTS cannot be calculated. Therefore, a PTS increase ptsd1 is calculated from the current frame rate cfr and the PTS increase ptsd1 is added to the current PTS to estimate the next PTS as described with respect to FIGS. 46 and 48.

In the discontinuous break point handling at a breakpoint, determination is made first as to whether an overwrite has occurred or not (step S16). The determination as to whether or not an overwrite had occurred is made on the basis of whether the overwrite count OWC in the overwrite information OWI is 0 (zero) or not. If an overwrite has not occurred, the determination at step S16 is NO and the PTS increase ptsd1 is calculated from the current frame rate cfr and the calculated PTS increase ptsd1 is added to the current PTS (curr_pts) to obtain the next PTS (step S18).

If an overwrite has occurred, the determination at step S16 is YES. Since the PTS and frame rate of the valid frame overwritten and lost are contained in the PTS and frame rate fields in the pre-read header information pHd, the PTS increase ptsd2 is calculated from the next frame rate (next_frame_rate; hereinafter referred to as the next frame rate) nfr stored and the calculated PTS increase ptsd2 is added to the next PTS to obtain the next PTS (step S19).

In the discontinuous time handling during transition, the current elapsed time (hereinafter referred to as the current ET) held in the elapsed time accumulating register 25a of the frame-to-be-extracted determining unit 25 is set as the next elapsed time (hereinafter referred to as the next ET) (step S17).

Since the discontinuous time handling during transition is a process during a stream change subsequent to a dummy frame that indicates a discontinuity, the process will end without increasing the elapsed time. Even though the elapsed time is not increased, the uniqueness problem does not arise because image processing is not applied to frames during transition. The value of the current ET is retained in order to carry the elapsed time at the discontinuity point over to the determination after the stream change. A frame during the transition can be a dummy frame or a frame for which a stream change flag c is set. While dummy frames may be successively received, the image processing is not applied to them because they are just dummies. Successive frames with a stream change occur because when a frame at the end of the stream was reached and then another stream has been inputted, a stream change flag c is inserted after the end of the former stream for the sake of convenience and therefore a stream change flag c is set in the next stream in succession. Image processing is not applied to the expediential frame.

If a result of the determination at step S14 other than those described above is provided, the process proceeds to error handling (step S12).

After step S15, S18 or S19, the frame-to-be-extracted determining unit 25 determines whether or not the inequality between the current PTS and the next PTS has been inverted. Here, the frame-to-be-extracted determining unit 25 determines whether the next PTS is smaller than the current PTS (step S20). Here, any decrease of the PTS that has not been indicated by a discontinuity flag is considered to be a return to 0 (zero). If this is the case, the determination at step S20 is YES and 2³³ is added to the PTS to compensate for or cancel the return to 0 (step S21).

If the determination at step S20 is NO or after step S21, the frame-to-be-extracted determining unit 25 calculates an actual increase (i.e. (next PTS-current PTS)) and determines whether or not the calculated value is approximately equal to the value estimated from the frame rate (i.e. (PTS increase×(overwrite count OWC+1))) (step S22). If an overwrite has occurred, the PTS is considered to have increased by an amount equivalent to the overwrite count OWC and the increase of the PTS is predicted. If the determination at step S22 is NO, that is, if the actual increase of the PTS does not approximately equal to the value predicted from the frame rate, alert information indicating a greater change of the PTS than the predicted value has occurred is outputted (step S23).

If the determination at step S22 is YES or after step S23, the frame-to-be-extracted determining unit 25 adds the actual increase (i.e. (next PTS-current PTS)) as the increase of the elapsed time (ET) to the current ET stored in the elapsed time accumulating register 25a to obtain the elapsed time for the frame relating to the pre-read header information pHd (hereinafter referred to as the next ET) (step S24). That is, next ET=current ET+next PTS−current PTS is calculated.

In this way, the frame-to-be-extracted determining unit 25 as a frame-to-be-processed determining unit can determine, on the basis of the overwrite count OWC in overwrite information OWI, whether an overwrite has occurred in the FIFO 21, and can determine the elapsed time (ET) from the start of the stream on the basis of whether an overwrite has occurred or not and of whether there is a discontinuity flag or not.

Then, determination is made as to whether or not the next PTS is greater than or equal to 2³³ (step S25). If the next PTS is greater than or equal to 2³³, the determination at step S25 is YES, and the frame-to-be-extracted determining unit 25 subtracts 2³³ from the next PTS and performs a predetermined action such as outputting alert information indicating that the PTS has returned to 0 (step S26).

The frame-to-be-extracted determining unit 25 stores the next ET obtained into the elapsed time accumulating register 25a and performs processing for determining a frame to be extracted (step S27). Since the current ET and the next ET, which is the pre-read elapsed time of one frame ahead, have been obtained, a frame to be extracted or skipped can be determined as described above.

Thus, the frame-to-be-extracted determining unit 25 can determine a frame to be extracted after determination at step S25 of NO, or after the step S17 or S26, in the manner described with respect to FIG. 43.

The frame-to-be-extracted determining unit 25 adds a predetermined flag or other indication to a frame to be extracted or a frame to be skipped.

In this way, the PTS and frame rate of a frame preceding or succeeding the point at which discontinuity exists can be obtained from the supplementary header information Shd. For a frame read from the FIFO 21 without discontinuity information, the frame-to-be-extracted determining unit 25 as a frame-to-be extracted determining unit determines the elapsed time ET from the start of the stream on the basis of the playback time instants of PTS of continuous two frames. For a frame with discontinuity information, the frame-to-be-extracted determining unit 25 determines the elapsed time ET from the start of the stream on the basis of the PTS and frame rate of the frame preceding or succeeding the point at which discontinuity exists. The frame-to-be-extracted determining unit 25 then determines a frame to which image processing is to be applied or to which the image processing is not to be applied, on the basis of the elapsed time ET determined and the set time interval f for specifying a frame to which the image processing is to be applied.

The image processing unit 26 applies the predetermined image processing only to frames to be extracted and outputs data resulting from the image processing to the CPU 13 or HDD, for example.

As has been described above, the image processing apparatus according to the present embodiment is capable of uniquely determining frames that correspond to specified time intervals from a stream as frames to which image processing is to be applied and applying the image processing, even when there is an error in a frame in the stream or when there is a discontinuity between frames.

Therefore, the present embodiment described above can provide an image processing apparatus capable of applying, for example, predetermined recognition processing (for example human face detection processing) to a stream and then applying another type of image processing (for example retouching) to frames recognized in the recognition processing.

Furthermore, according to the present embodiment, image processing by an image processing program can be applied to the same frames in the same stream, therefore the image processing program can be accurately evaluated during development of the image processing program.

In the image processing apparatus and the image processing method according to the embodiment of the present invention described above, when image processing is to be applied to an image sequence decoded from a moving image stream at such a frequency that the processed frames appear at a regular intervals in playback time of a moving image, for example when face detection processing is to be performed 10 times per second of playback time of a moving image, the uniqueness of frames selected as frames to which image processing is to be applied can be ensured even if the computational load of the image processing varies depending on the content of the image. That is, frames to which image processing is to be applied can be always uniquely determined independently of the timing of decoding and image processing of a moving image and whether the processing has been skipped, suspended, or resumed.

Moreover, when image processing is distributed among multiple apparatuses and performed on the apparatuses in parallel, the image processing can be applied to the same frames on the multiple apparatuses. For example, one of two apparatuses can perform a first type of image processing and the other apparatus can perform a second type of image processing on the same frame of a moving image stream. This can eliminates the need for synchronization or communication between the apparatuses for enabling the apparatuses to apply the processing to the same frames.

Furthermore, the reproducibility of the result of image processing can be ensured, which help users such as developers develop an image processing apparatus or an image processing program or correct defects in the image processing apparatus and the image processing program. That is, when image processing is applied to the same moving image stream multiple times, the image processing can be applied to the same frames during the first and second iterations, for example.

The image processing apparatus according to the embodiment described above is effective when it is desired to perform image processing such as recognition processing for detecting a human face while a television broadcast program is being recorded on an image processing apparatus capable of recording television broadcast.

While the exemplary embodiment have been described with respect to an a television broadcast stream by way of example, the image processing apparatus according to the embodiment described above is also applicable to image data recorded on a storage medium such as a DVD and image data shot with a movie camera.

Thus, since a frame to which image processing is to be applied can be uniquely determined from among multiple frames in a stream, predetermined image processing can be applied to the determined, or identified frame, and various additional image processing can be applied to the frame.

The “units” as used herein are conceptual equivalents to functions of embodiments and are not necessarily in one-to-one correspondence to specific hardware components or software routines. Accordingly, the embodiment has been described herein with respect to imaginary circuit blocks (units) having the functions of the present embodiment. The steps of any of the processes in the present embodiment may be performed in other order, or some of the steps may be performed at a time, or the steps may be performed in different orders in different runs unless the order is inconsistent with the nature of the process.

All or part of program codes of a program that executes the operations described above is recorded or stored as a computer program product on a portable medium such as a flexible disk or CD-ROM, or a storage medium such as a hard disk. The program is read by a computer and all or part of operations is performed by the computer. Alternatively, all or part of the codes of the program can be distributed or provided through a communication network. A user can download and install the program on a computer through the communication network or install the program on a computer from the storage medium to readily implement the image processing apparatus of the present invention.

The present invention is not limited to the embodiment described above. Various changes and modification can be made to the embodiment without departing from the spirit of the present invention.

What is claimed is:

1. An image processing apparatus comprising:
a discontinuity detecting unit configured to detect discontinuity between frames in stream data having a plurality of pieces of frame data including image data, a playback time instant, and a frame rate and, when the discontinuity is detected, add predetermined discontinuity information indicating the presence of the discontinuity and output the image data and header information of each frame;
a FIFO memory configured to store the image data and the header information from the discontinuity detecting unit in association with each of the frames; and
a frame-to-be-processed determining unit configured to determine, for a frame read from the FIFO memory without the discontinuity information, elapsed time from the start of stream data on the basis of the playback time instants of two continuous frames, and determine, for a frame to which the discontinuity information is added, elapsed time from the start of the stream data on the basis of the playback time instant and the frame rate of a frame preceding or succeeding the point at which the discontinuity exists, and determine a frame to which the image processing is to be applied or a frame to which the image processing is not to be applied, on the basis of the determined elapsed time and time intervals set for specifying a frame to which the image processing is to be applied.

2. The image processing apparatus according to claim 1, further comprising a elapsed time accumulating register configured to accumulate elapsed time from the start of the stream, wherein the elapsed time accumulating register stores the elapsed time determined.

3. The image processing apparatus according to claim 1, wherein the header information includes the discontinuity information, the playback time instant, and the frame rate.

4. The image processing apparatus according to claim 3, wherein the discontinuity information includes information indicating a change of the stream, an end of the stream, and an end of a sequence contained in the stream.

5. The image processing apparatus according to claim 4, further comprising a supplementary header generating unit configured to generate supplementary header information including the number of overwrites, the number of overwrites after a change of the stream, an indication of presence or absence of a change of the stream, an indication of the presence or absence of an end of the stream, an indication of the presence or absence of an end of the sequence, the playback time instant at which a change of the stream has occurred, the playback time instant immediately before an end of the sequence, and the frame rate immediately before an end of the sequence on the basis of information indicating the number of overwrites on the FIFO memory, a change of the stream, an end of the stream, and an end of the sequence;
wherein the frame-to-be-processed determining unit obtains the playback time instant and the frame rate of a frame preceding or succeeding the point at which the discontinuity exists from the supplementary header information generated by the supplementary header generating unit.

6. The image processing apparatus according to claim 5, wherein the supplementary header generating unit generates the playback time instant immediately before the end of the sequence and the frame rate immediately before the end of the sequence by continuing to copy the playback time instant and the frame rate from the header information until the occurrence of the end of the sequence.

7. The image processing apparatus according to claim 5, wherein the supplementary header generating unit generates the playback time instant at which a change of the stream has occurred by copying the playback time instant from the header information when the change of the stream has occurred for the first time.

8. The image processing apparatus according to claim 5, further comprising a header information manipulating unit configured to, when reading the image data and the header information of an oldest frame stored in the FIFO memory, read the header information of a second oldest frame together with the image data and the header information of the oldest frame and manipulate the header information of the second oldest frame on the basis of the supplementary header information generated by the supplementary header generating unit.

9. The image processing apparatus according to claim 5, wherein the header information manipulating unit generates overwrite information including the number of overwrites from the supplementary header information.

10. The image processing apparatus according to claim 9, wherein the frame-to-be-processed determining unit determines whether an overwrite has occurred in the FIFO memory on the basis of the number of overwrites in the overwrite information and determines the elapsed time from the start of the stream on the basis of whether the overwrite has occurred.

11. A image processing method comprising:
detecting discontinuity between frames in stream data having a plurality of pieces of frame data including image data, a playback time instant, and a frame rate and, when the discontinuity is detected, adding predetermined discontinuity information indicating the presence of the discontinuity to the image data and outputting the image data and header information of each frame; and
for a frame without the discontinuity information read from the FIFO memory configured to store the output image data and the output header information in association with each of the frames, determining elapsed time from the start of stream data on the basis of the playback time instants of two continuous frames, and for a frame to which the discontinuity information is added, determining elapsed time from the start of the stream data on the basis of the playback time instant and the frame rate of a frame preceding or succeeding the point at which the discontinuity exists, and determining a frame to which the image processing is to be applied or a frame to which the image processing is not to be applied, on the basis of the determined elapsed time and time intervals set for specifying a frame to which the image processing is to be applied.

12. The image processing method according to claim 11, wherein the header information includes the discontinuity information, the playback time instant, and the frame rate.

13. The image processing method according to claim 12, wherein the discontinuity information includes information indicating a change of the stream, an end of the stream, and an end of a sequence contained in the stream.

14. The image processing method according to claim 13, further comprising:
generating supplementary header information including the number of overwrites, the number of overwrites after a change of the stream, an indication of presence or absence of a change of the stream, an indication of the presence or absence of an end of the stream, an indication of the presence or absence of an end of the sequence, the playback time instant at which a change of the stream has occurred, the playback time instant immediately before an end of the sequence, and the frame rate immediately before an end of the sequence on the basis of information indicating the number of overwrites on the FIFO memory, a change of the stream, an end of the stream, and an end of the sequence;
wherein the playback time instant and the frame rate of a frame preceding or succeeding the point at which the discontinuity exists are obtained from the supplementary header information.

15. The image processing method according to claim 14, wherein the playback time instant immediately before the end of the sequence and the frame rate immediately before the change of the sequence are generated by continuing to copy the playback time instant and the frame rate from the header information until the occurrence of the end of the sequence.

16. The image processing method according to claim 14, wherein the playback time instant at which a change of the stream has occurred is generated by copying the playback time instant from the header information when the change of the stream has occurred for the first time.

17. The image processing method according to claim 14, further comprising:
when reading the image data and the header information of an oldest frame stored in the FIFO memory, reading the header information of a second oldest frame together with the image data and the header information of the oldest frame and manipulating the header information of the second oldest frame on the basis of the supplementary header information generated by the supplementary header generating unit.

18. The image processing method according to claim 14, wherein overwrite information is generated from the number of overwrites included in the supplementary header information.

19. The image processing method according to claim 18, whether an overwrite has occurred in the FIFO memory is determined on the basis of the number of overwrites in the overwrite information, and the elapsed time from the start of the stream is determined on the basis of whether the overwrite has occurred.

20. A storage medium on which an image processing program is stored, comprising the code sections of:
detecting discontinuity between frames in stream data having a plurality of pieces of frame data including image data, a playback time instant, and a frame rate and, when the discontinuity is detected, adding predetermined discontinuity information indicating the presence of the discontinuity and outputting the image data and header information of each frame; and
for a frame without the discontinuity information read from the FIFO memory configured to store the output image data and the output header information in association with each of the frames, determining elapsed time from the start of stream data on the basis of the playback time instants of two continuous frames, and for a frame to which the discontinuity information is added, determining elapsed time from the start of the stream data on the basis of the playback time instant and the frame rate of a frame preceding or succeeding the point at which the discontinuity exists, and determining a frame to which the image processing is to be applied or a frame to which the image processing is not to be applied, on the basis of the determined elapsed time and time intervals set for specifying a frame to which the image processing is to be applied.
